(19) United States
(12) Patent Application Publication
(10) Pub. No.: US 2018/0045522 A1
(43) Pub. Date: Feb. 15, 2018

(54) Sky Machines

(71) Applicant: Skymachines, Inc., Coral Gables, FL (US)

(72) Inventor: Ashar Aziz, Coral Gables, FL (US)

(21) Appl. No.: 15/675,402

(22) Filed: Aug. 11, 2017

Related U.S. Application Data
(60) Provisional application No. 62/374,754, filed on Aug. 13, 2016.

(51) Int. Cl. G01C 21/34; G05D 1/10; G08G 5/00

(52) U.S. Cl. CPC G01C 21/3407; G08G 5/0004; G08G 5/0047; G08G 5/0095; G05D 1/104; G05D 1/102

(57) ABSTRACT

A method for accessing and navigating an aerial vehicle on a three-dimensional map of transportation skyways comprises requesting, from an aerial-vehicle-transportation database, a driving map based on a three-dimensional representation of one or more transportation skyways, the three-dimensional representation comprising information regarding an x-axis and a y-axis representing movement in a first plane and information regarding a z-axis representing movement in a second plane perpendicular to the first plane; receiving the driving map generated based on the information on the x-axis and the y-axis of movement, the driving map being determined based on the three-dimensional representation; receiving information on altitude-transition zones associated with the z-axis of movement of the aerial vehicle along the second plane; and storing, in a navigation system of the aerial vehicle, navigation information comprising the driving map and the altitude-transition zones.

### PRIORITY

This application claims priority under 35 U.S.C. §119 to U.S. Provisional Patent Application No. 62/374,754, filed 13 Aug. 2016.

### TECHNICAL FIELD

This disclosure generally relates to transportation vehicles and related infrastructure.

### BACKGROUND

The concept of flying cars has long occupied people's imagination, both in sci-fi books and movies and in the expectations of people in terms of the evolution of future personal transportation. Beyond the “sci-fi cool” appeal of an aerial personal transportation vehicle, there are significant societal and practical day-to-day advantages of cars that are not restricted to driving on terrestrial roads and freeways.

Traffic congestion is rapidly increasing in large cities around the world due to massive population increases in these cities. In several mega-cities around the world, it is projected that traffic will come to a near standstill if the rate of cars being added to the traffic mix continues on its current trajectory. This is because the rate of cars being added to the city's traffic exceeds the rate at which new road or freeway capacity is being added to the cities. Many of these cities lack both the adequate highway infrastructure and also access to the capital required to construct additional highways to alleviate the growing traffic congestion. And it is becoming increasingly difficult to deliver emergency medical transportation services, such as those provided by ambulances, in cities where the traffic simply doesn't move. There are increasing reports of deaths occurring due to the inability of ambulances to get patients to medical centers in a timely fashion during peak traffic congestion hours and associated traffic gridlock.

In addition to the life and death issues related to ambulances stuck in traffic, there are day-to-day problems arising from increasing traffic congestion. Long commute hours during peak traffic hours, road rage and frustration, time wasted while stuck in traffic jams are just some of the problems related to our inability to successfully evolve urban transportation into an architecture that is less prone to daily congestion and wasted commute hours. Society as a whole suffers from a 20^{th} century urban transportation infrastructure that has become increasingly congested, difficult to adapt and inefficient in its ability to provide effective and timely personal transportation.

The number of cities around the world that suffer these horrendous and worsening traffic congestion related commutes is long and includes Beijing, Mexico City, Johannesburg, Moscow, New Delhi, Mumbai, Dhaka, Sao Paulo, Tokyo, London, New York, Los Angeles, Karachi, Lahore, Bangalore and Toronto to name just a few. Time wasting commutes carries with it enormous economic costs. Commuting costs America alone an estimated $90 billion dollars per year in terms of lost productivity and wasted energy, according to the annual Urban Mobility Report.

Appealing as the concept of flying cars might be to alleviate the worsening global problems in mega-cities due to traffic congestion, there are very significant technological, societal evolution and security and safety challenges in successfully evolving urban transportation beyond terrestrial road driven cars to cars (or vehicles) that have aerial capabilities at the scale of the urban populations of these large mega-cities.

The first very significant societal evolution challenge is the “drivability” of such an aerial vehicle. While car driving is a skill that has been demonstrated to be easily acquired by the vast majority of people, aircraft flying skills are significantly more challenging. It is not reasonable to expect that a significant fraction of the world's population will easily evolve their skill sets to piloting aerial cars, as trained pilots fly commercial airplanes or helicopters today. And this is a significant issue when one is talking about mass-scale adoption of aerial vehicles for personal intra-city transportation.

Flight passenger and population safety is another significant challenge. Any transportation system evolution that involves a large numbers of aerial vehicles has to contend with flight and urban population safety issues as well, where inadequate air traffic management and control should not result in mid-air collisions. The safety of the population over which such vehicles will be flying needs to be highly assured. The probability of air vehicle collisions or crashes due to equipment or driver failures over populated urban centers would have to be dramatically low in order to have a mass adopted aerial transportation system that is acceptable to society as a whole.

Free-form and unconstrained aerial flights, numbering in hundreds of thousands or millions, in close vicinity to each other, without some of form of air traffic management would be a safety nightmare, with the possibility of both mid-air collisions and crashes of aerial cars on populated sections of the city.

However, effective central air traffic control, as it exists for commercial airline traffic for hundreds of thousands of aerial vehicles flying in close proximity to each other in urban areas is potentially an insurmountable technical challenge. Central air traffic control can barely handle the growth of commercial airline traffic operating in the relative open spaces of commercial airports. Hundreds of thousands of aerial vehicles flying about close to each other inside densely populated cities is not something that can easily be handled by any central air traffic control technology or infrastructure that has been developed or is likely be developed in the foreseeable future.

Another significant issue is security in the era of urban terrorism, where bomb laden aerial vehicles can be used to attack various urban targets. If thousands of such cars are flying around, the challenge of successfully policing the skies from terrorist commandeered bomb-laden aerial vehicles becomes a significant security challenge. In addition to terrorism, an aerial vehicle in the hands of a mentally ill person provides an instrument for dramatic murder/suicide scenarios if the mentally ill driver chooses to intentionally crash the aerial vehicle on people or buildings.

### SUMMARY OF PARTICULAR EMBODIMENTS

Particular embodiments may include a driving user interface (e.g., a skyframe) for individual aerial transportation vehicles. As an example and not by way of limitation, the driving user interface may present a two-dimensional (2D) interface based on a three-dimensional (3D) constraint map (e.g., skyways) where the 2D interface allows a user to “drive” the vehicle using a 2D paradigm while handling altitude transitions transparently. As an example and not by way of limitation, the handling of the altitude transitions may extend to handling transitions between driving on a solid surface (e.g., a road) and on an aerial transportation lane (e.g., a skyway). In particular embodiments, the 3D motion constraint map may be comprised of designated paths that constrain the lateral and vertical motion of the vehicle, as well as direction (e.g., similar to a surface road that constrains where a conventional car may legitimately drive). In particular embodiments, the path information may be received from a centralized control system, to which the vehicle broadcasts its position and/or location. The path information may also specify particular areas where altitude transitions are permitted (e.g., similar to a freeway exit).

Particular embodiments may include a navigation system for individual driving user interfaces based on a 3D motion constraint map. As an example and not by way of limitation, the driving user interface may monitor nearby vehicles and maintain safe distances. As another example, the driving user interface may link up with other vehicles to optimize individual laminar flow and system-wide traffic flow. As yet another example, the driving user interface may offer full autopilot navigation based on detected origin and user-input destination. As yet another example, the driving user interface may include security mechanisms, e.g., requiring pre-flight check for any updated software notifications, verification of software, verifying digital signatures on received path information, etc. In particular embodiments, motion controlled by the driving user interface may include dual-rotor “skybikes,” quad-rotor “skycars,” and/or super-multi-rotor “skybuses.” In addition, the driving user interface may be able to elevate the aerial transportation vehicles substantially vertically (e.g., while in Skyshaft), and may be able to hover above surface roads and “drive without tires” by flying, and may be able to make substantially sideways movement (e.g., while hovering).

Particular embodiments may include path detection for a regional 3D navigation system. As an example and not by way of limitation, the 3D navigation system may perform 3D scanning of environment and detecting/marking boundaries of unavailable 3D spaces (e.g., permanent structures, trees/greenery, aerial wires, flags, signage) in order to generate 3D map of navigable paths within a given region (e.g., city, metropolitan area, large private property). As another example, the 3D navigation system may assign buffer zones around unavailable 3D spaces, and detect/mark 2D paths, altitude transition points/regions, parking/stopping areas, Skyshafts, etc. As yet another example, the 3D navigation system may include a configuration for intersection management, speed-limited zones/paths, toll zones/paths/time periods, high-altitude expressways with altitude-transitioning “exits” to lower-altitude “local roads.”

Particular embodiments may include a centralized control system for the 2D navigation interface for 3D motion. As an example and not by way of limitation, the centralized control system may broadcast path information and send updates to individual vehicles. As another example, the centralized control system may monitor traffic flow/congestion, accidents, emergencies, and push out recommendations/commands to vehicles to take alternate routes. As yet another example, the centralized control system may seamlessly update the 3D map based on actual or projected addition/elimination of unavailable 3D spaces, monitoring of weather patterns, and creation/deletion of temporary event-based (e.g., planned future event or immediate emergency) modifications to the 3D map.

In particular embodiments, an in-vehicle display for a 2D interface may be presented on the driving user interface. As an example and not by way of limitation, the 2D interface may include a heads-up display on one or more windows or a combination camera-driven video stream with super-imposed 2D path markers.

In particular embodiments, drones may be configured to mark paths on the skyways (e.g., skybots). As an example and not by way of limitation, these drones may be controlled by the centralized control system, and may be deployed to particular locations to mark paths and control traffic flow. As another example, these drones may serve a gatekeeper function by requiring authentication by skyframes, as well as verification of the skyframe's hardware and software. In particular embodiments, the drones may be able to “hot-swap” when a skybot needs to recharge/refuel. In particular embodiments, the drones may illuminate the path at night/dusk, and may display messages or advertisements. In particular embodiments, the drones may monitor weather/turbulence/air currents and transmit information back to centralized control system, and may provide information to enable aerial transportation vehicles to adjust to counter turbulence.

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example urban area with surface transportation lanes.

FIG. 2 illustrates an example three-dimensional urban area with multiple aerial transportation lanes (e.g., a first level and a second level) and vehicles.

FIG. 3 illustrates an example two-dimensional urban area with a single aerial transportation lane (e.g., the second level shown from above).

FIG. 4 illustrates an example two-dimensional urban area with another aerial transportation lane at a different level shown from above (e.g., the first level shown from above).

FIG. 5 illustrates the ground transportation lanes of the urban area shown from above.

FIG. 6 illustrates an example three-dimensional urban area with multiple aerial transportation lanes highlighted by skybots.

FIG. 7 illustrates an example aerial transportation lane and a terrestrial freeway lane.

FIG. 8 illustrates an example aerial transportation lane with skybots.

FIG. 9 illustrates an example aerial transportation lane with skybots and skybot light beams.

FIG. 10 illustrates an example aerial transportation vehicle moving on an aerial transportation lane with skybots.

FIG. 11 illustrates an example skyshaft for moving an aerial vehicles from a skyway to a building top.

FIG. 12 illustrates an example aerial transportation vehicle.

FIG. 13A illustrates a rotor assembly for an aerial transportation vehicle. FIG. 13B illustrates another embodiment of a rotor assembly for an aerial transportation vehicle. FIG. 13C illustrates a third embodiment of a rotor assembly for an aerial transportation vehicle. FIG. 13D illustrates a fourth embodiment of a rotor assembly for an aerial transportation vehicle.

FIG. 14 illustrates an example method for accessing and displaying a three-dimensional map of transportation skyways.

FIG. 15 illustrates an example method for navigating an aerial vehicle on the three-dimensional map of transportation skyways.

FIG. 16 illustrates an example method of accessing an two-dimensional navigation interface using the three-dimensional map of transportation skyways.

FIG. 17 illustrates an example method of controlling a plurality of location markers via a centralized control system.

FIG. 18 illustrates an example computer system.

### DESCRIPTION OF EXAMPLE EMBODIMENTS

Generally, sky machines comprise transportation vehicles that may operate both on the ground and in the air.

### Partially Constrained Aerial Motion (PCAM)

In particular embodiments, the Sky Machine architecture comprises Partially Constrained Aerial Motion (PCAM), which is the ability to combine human driver input with computer or software derived input in order to control, manage and constrain the motion of an aerial vehicle, which remains only partially under the user's control and partially under the flight computer's software control. A 3D motion constraint map, stored inside the aerial vehicle's flight computer may supply the flight movement constraints. PCAM flight control software may interpret the 3D constraint map and takes the human driver's input to “drive” or “fly” the vehicle only within the constraints described by the 3D motion constraint map, by transparently generating additional flight control signals to the aerial motion control system. As an example and not by way of limitation, PCAM flight control software may allow the human driver to control movement of an aerial vehicle along one plane (e.g., a first plane represented by an x-axis and y-axis) while controlling movement of the aerial vehicle along a second plane (e.g., a plane represented by a z-axis to represented a height or elevation and perpendicular to the first plane) by constraining movement and not allowing the human driver to control the movement in this plane, as discussed in more detail below.

### Virtual Freeways or Skyways

In particular embodiments, a 3D motion constraint map, for example, a virtual freeway (or road) providing the illusion of a terrestrial “freeway” to an aerial vehicle driver, may be used to navigate the aerial vehicle. In particular embodiments, a virtual freeway may be stored in the memory sub-systems of computers in the Sky Machines architecture, e.g., the flight computers of the aerial vehicles that use the data in this 3D map to control, constrain and transparently manage the aerial movement of the vehicle along the routes and elevations indicated by the virtual freeways.

The driver input and overall user-driving experience may be similar if not identical to what a driver experiences when driving a traditional road driven vehicle on a terrestrial freeway (e.g., driving on the plane represented by the x-axis and y-axis) such as, for example, speed control, by virtue of an accelerator and a brake, and forward/reverse motion using forward/reverse gears and left/right turns as indicated by a car's steering wheels or motorbike handles. In particular embodiments, the experience may be similar to a 2D driving experience much like a terrestrial car driving experience.

In particular embodiments, on a virtual freeway, elevation control may be transparently affected by using the virtual elevation of the virtual freeway (e.g., a skyway) indicated in the 3D constraint map. This may be similar to how a car may be driven on a terrestrial freeway with changing height or elevation. As an example and not by way of limitation, the driver of a terrestrial vehicle (e.g., a car) does not directly control the height or elevation dimension of the vehicle (e.g., along the z-axis), as that is affected by the elevation of the terrestrial road or freeway itself. The driver experience in terms of controlling a terrestrial vehicle's direction and motion is that of a 2D motion control experience, using the traditional 2D motion controls of a car, while the road's elevation or height affects the third dimension (or elevation) of the car being driven on it. Cars may move transparently in the third dimension, because a physical construct, a terrestrial road or freeway, affects the position of the car in the third dimension of elevation or height.

Inside an aerial vehicle the physical controls themselves may resemble or be identical to those of existing cars, e.g. a steering wheel, a brake pedal and an accelerator pedal, and forward/reverse gears, etc. There may be nothing inside the aerial vehicle that resembles the physical operational controls of an airplane e.g. rudder/aileron controls using a joystick or the cyclic/collective stick based controls of a helicopter.

When an aerial vehicle, under PCAM flight control, is “driven” on a skyway, it may transparently elevate itself to the elevation (e.g., PCAM controlled along the z-axis), which is described for that location using the virtual construct of a skyway. Aerial vehicles operating under PCAM flight control software may be described as “sky vehicles.” The signals to elevate the car to the desired elevation (e.g., along the z-axis), as indicated in the skyway's 3D map, may be automatically computed by the flight computer that implements PCAM flight control and signaled to the aerial motion control system. The driver supplies mostly 2D motion control information as he or she would for driving a terrestrial car.

Just as an elevated terrestrial freeway may transparently affect the elevation of a terrestrial vehicle driving on top of it, a skyway may transparently affect the elevation of a sky vehicle. As an example and not by way of limitation, as the skyway “rises,” so does the sky vehicle “driving” on top of it rise, and when the skyway “descends,” the sky vehicle correspondingly drops its elevation, without any driver supplied input instructing the sky vehicle either to go up or to go down.

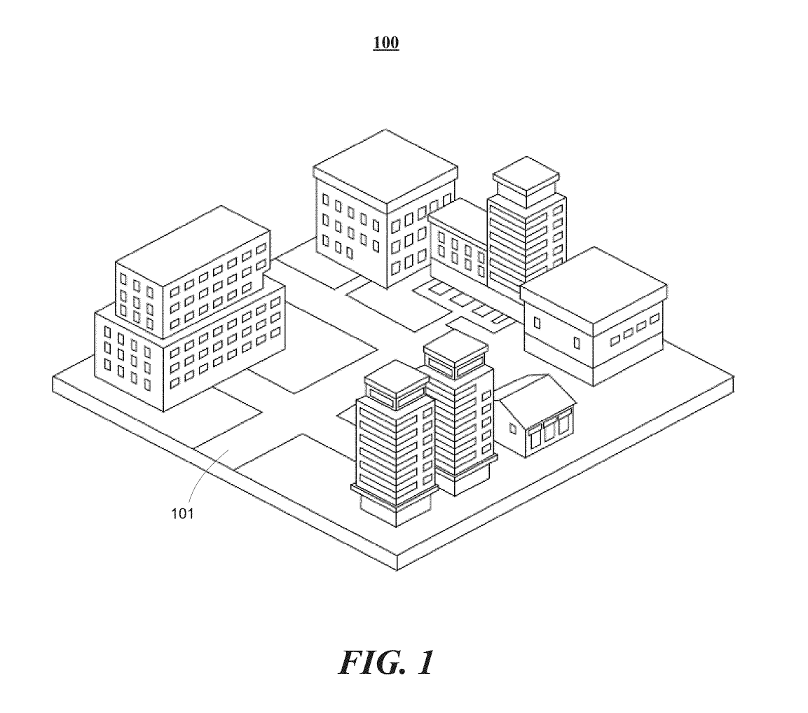

Using the same physical driving controls as traditional cars leverages the familiarity that billions of drivers have with these existing terrestrial driving controls. FIG. 1 illustrates an example urban area 100 with surface transportation lanes. As shown in FIG. 1, urban area 100 includes one or more roads 101 that drivers may traverse to get from a first location to a second location.

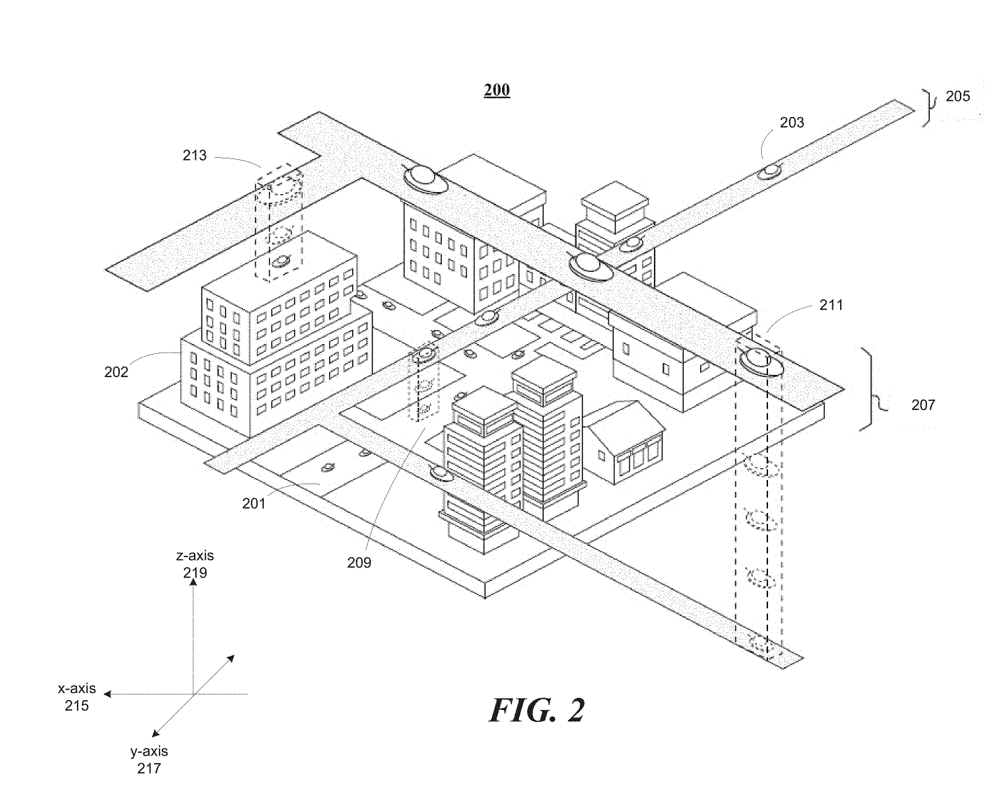

FIG. 2 illustrates an example three-dimensional urban area 200 with multiple aerial transportation lanes and vehicles. As shown in FIG. 2, urban area 200 includes a first transportation lane 201 at ground level (e.g., a terrestrial freeway lane) on which sky vehicles 203 may traverse along, a plurality of buildings 202, a second transportation lane 205 (e.g., a first skyway) at a first aerial level above ground level, and a third transportation lane 207 (e.g., a second skyway) at a second aerial level above both the ground level and the first aerial level. In addition, FIG. 2 shows skyshafts 209, 211, and 213 for moving sky vehicles vertically down from a skyway. For example, skyshaft 209 may move sky vehicles 203 from second transportation lane 205 to first transportation lane 201 (or vice versa), skyshaft 211 may move sky vehicles 203 from third transportation lane 207 to second transportation lane 205 (or vice versa), and skyshaft 213 may move sky vehicles 203 from third transportation lane 207 onto the roof of building 202 (or vice versa). As an example and not by way of limitation, sky vehicle 203 may drive to and position itself on top or bottom of the virtual vertical drop location. The sky vehicle 203 may then descend vertically down such a designated “virtual shafts” and land on the rooftop (e.g., of building 202) or street parking or other designated landing spot. Similarly, the vehicle may fly vertically up such a vertical pathway from a rooftop parking lot and then join and fly onto the skyway. As an example and not by way of limitation, if a skyway is analogous to a freeway in the physical world, then the analogy in the physical world to a (virtual) sky shaft is a physical car elevator shaft. As shown in FIG. 2, sky vehicle 203 may move along a plane determined by an x-axis 215 and a y-axis 217 (e.g., by the driver's direction), and also along a plane determined by z-axis 219 and perpendicular to the x-y plane (e.g., under PCAM flight control).

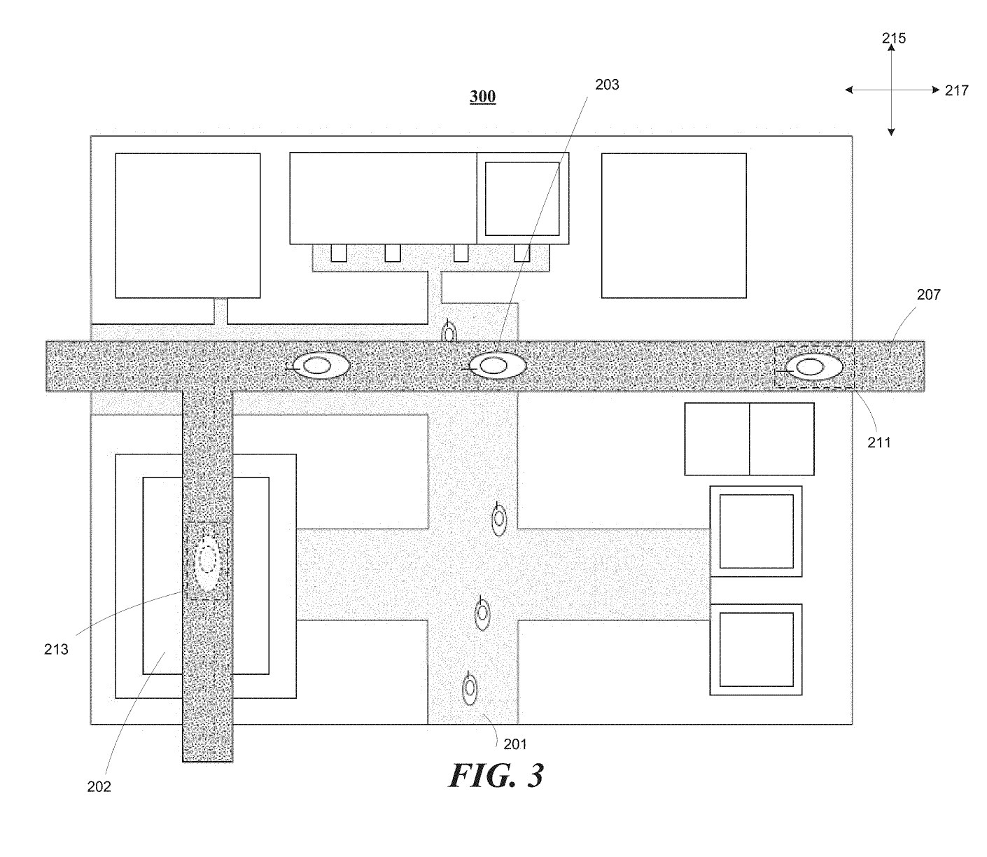

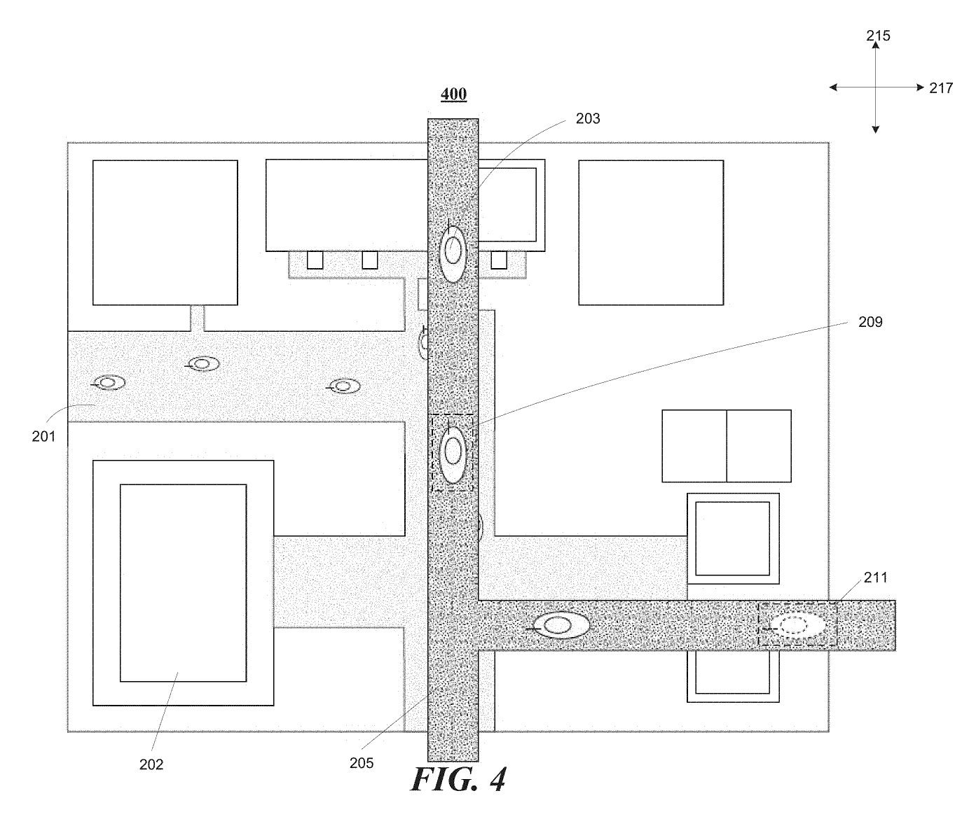

FIG. 3 illustrates an example two-dimensional urban area 300 (e.g., along x-axis 215 and y-axis 217) with a single aerial transportation lane shown from above. FIG. 3 shows the location of building 202 and sky vehicles 203 moving along third transportation lane 207 (e.g., the second skyway). FIG. 3 also shows sky vehicles 203 moving up/down skyshaft 211 between third transportation lane 207 and second transportation lane 205, and up/down skyshaft 213 between third transportation lane 207 and the roof of building 202.

FIG. 4 illustrates an example two-dimensional urban area 400 (e.g., along x-axis 215 and y-axis 217) with another aerial transportation lane at a different level shown from above. FIG. 4 shows the location of building 202 and sky vehicles 203 moving along second transportation lane 205 (e.g., the first skyway). FIG. 4 also shows sky vehicles 203 moving up/down skyshaft 211 between third transportation lane 207 and second transportation lane 205, and up/down skyshaft 209 between second transportation lane 205 to first transportation lane 201.

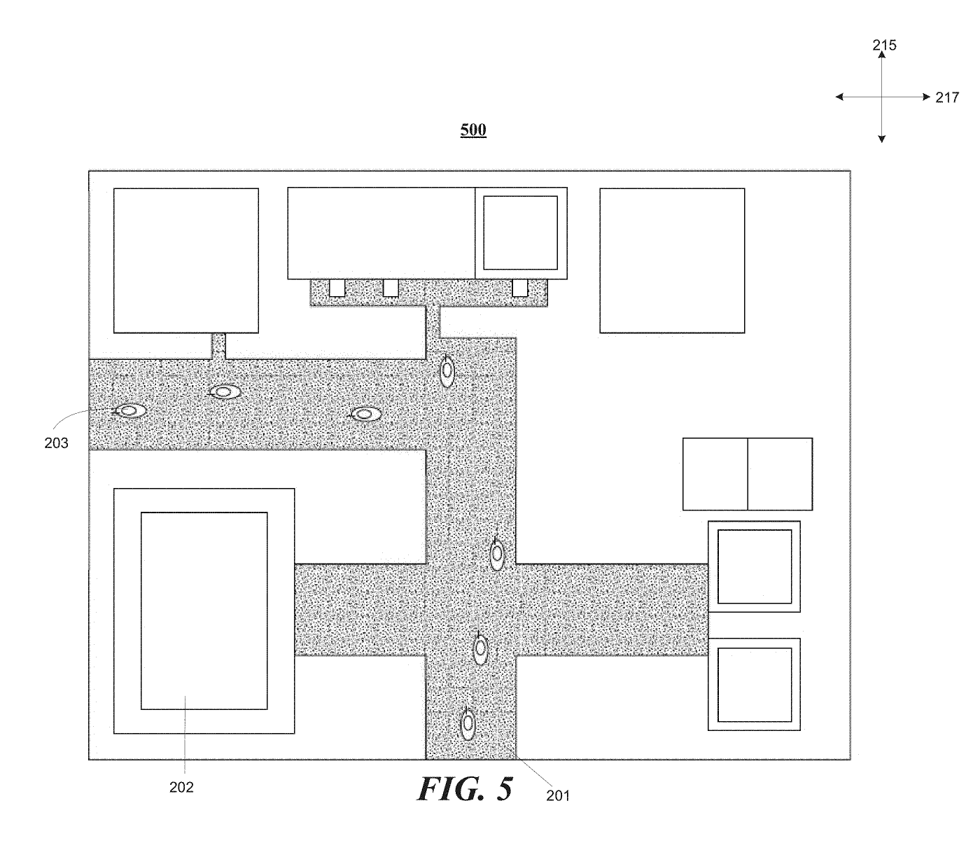

FIG. 5 illustrates an example two-dimensional urban area 500 (e.g., along x-axis 215 and y-axis 217) with the transportation lanes of the urban area shown from above. FIG. 5 shows the location of building 202 and sky vehicles 203 moving along first transportation lane 201 (e.g., the terrestrial freeway lane). In particular embodiments, the driver experience of a person driving an aerial vehicle on a skyway may be very similar to the experience of a person driving a car on a terrestrial road or freeway. Maintaining a familiar user experience may be helpful for large swaths of society to transition and adopt the concept of flying over the cities in which they currently drive, constrained by gravity, to terrestrial roads.

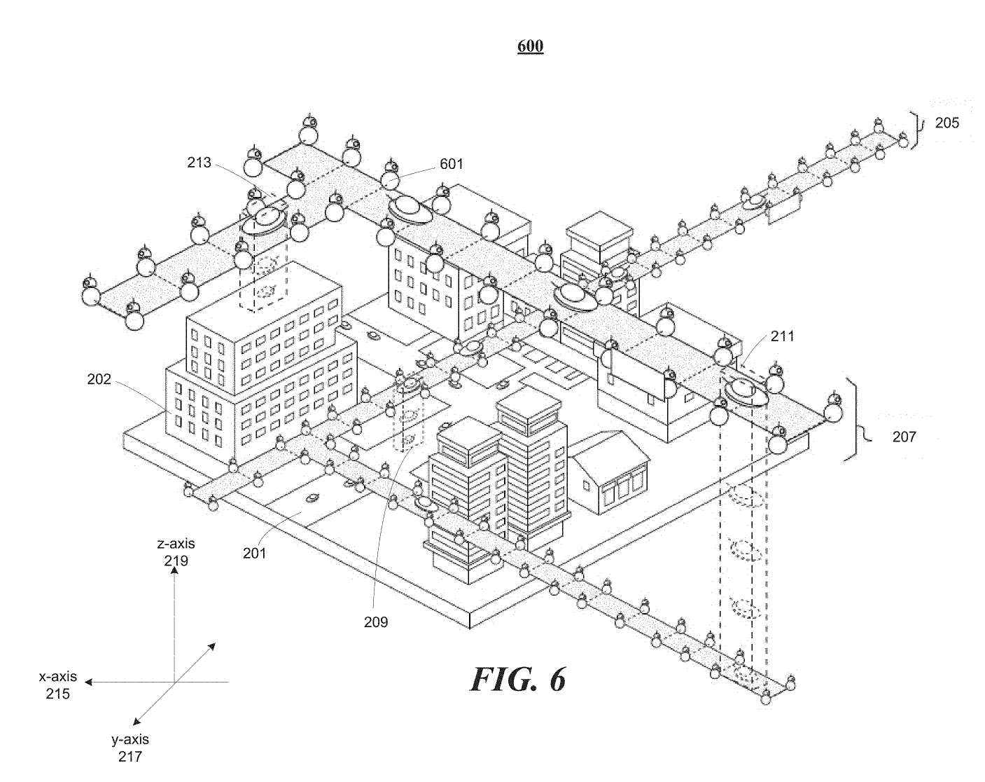

FIG. 6 illustrates an example three-dimensional urban area 600 with multiple aerial transportation lanes highlighted by skybots 601, which will be discussed in more detail below.

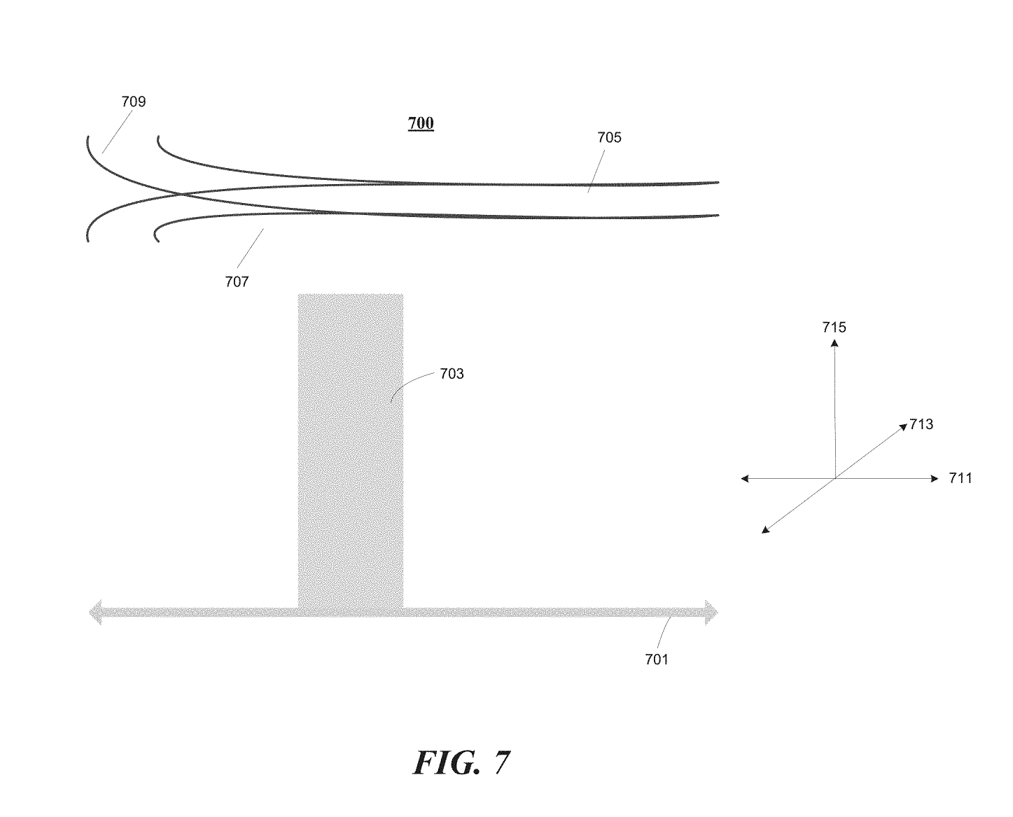

FIG. 7 illustrates an example three-dimensional urban area 700 with an example aerial transportation lane and a terrestrial freeway lane. As shown in FIG. 7, urban area 700 includes a first transportation lane 701 at ground level (e.g., a terrestrial freeway lane) on which sky vehicles (e.g., sky vehicles 203) may traverse along, building 703, and second transportation lane 705 (e.g., the first skyway) at the first aerial level above ground level. As shown in FIG. 7, second transportation lane 705 may split into two lanes to become third transportation lane 707 and fourth transportation lane 709. In addition, FIG. 7 shows that the sky vehicles (e.g., sky vehicle 203) may move along a plane determined by x-axis 711 and y-axis 713 (e.g., by the driver's direction), and also along a plane determined by z-axis 715 and perpendicular to the x-y plane (e.g., under PCAM flight control). FIG. 7 illustrates the similarity between skyways and freeways, and shows that they may be interconnected and split or merged together, much as different physical freeways interconnect and split and mix together in the physical world. FIG. 7 shows an elevated skyway, above a building, which splits into two separate skyways. In general, skyways may resemble freeways and may be interconnected into other skyways using on-ramps or off-ramps, and also to physical freeways, at special physical and virtual freeway interconnection points.

In particular embodiments, for the PCAM flight control, while the driver may drive on the skyway system, turn on to different skyways and change lanes on a given skyway, the driver cannot drive off the skyway system, as discussed in more detail below. The sky vehicle's motion may be constrained to stay only on the permitted lanes of the skyways, much like the physical side-barriers of an elevated freeway prevent a car from driving off a terrestrial freeway. Any attempt to “drive off” or fly off the skyway system by the driver of the sky vehicle may be ignored by the PCAM flight control software inside the sky vehicle's flight computer. The flight computer may only accept that part of the user input that allows the vehicle to continue to drive on the skyway system. The user may drive forward or backwards, change lanes, take turns onto other skyways that connect logically to the one the user is driving on, but the user cannot drive off the skyway system in the way an unconstrained aerial flight vehicle such as a helicopter or an airplane may essentially fly anywhere it is instructed to fly by the pilot.

In particular embodiments, there may be different ways to implement the behavior of a sky vehicle if the driver attempts to drive outside the 3D constraint map. One may be to mimic what would happen to a car when it hits a road's side barrier, namely it would bounce off the barrier with some force. Another may be to implement a soft control where the user input is simply ignored as an attempt is made to drive off the 3D motion constraint map. Different use cases of sky vehicles may have different ways of enforcing the behavior of a sky vehicle if it attempts to drive outside the 3D motion constraint map. For example, for transportation use cases, one could implement a soft control and behavior implementing the motion constraint. In certain gaming applications, as described below, it may be better to mimic the “bounce off with some force” aspect of a car hitting a road's side barrier.

In particular embodiments, the PCAM flight control may be different from an airplane's autopilot function, which exercises complete control of the motion of an airplane. An airplane essentially has two modes of flight; pilot control where all the input is provided by a human pilot, and autopilot control, where all the input is provide by the on-board flight computer. A sky vehicle may be neither mode as, at most times, the vehicle is under partial user control, for the two dimensional aspects of navigation, and PCAM software flight control, using the virtual construct of a skyway and its associated 3D constraint map, to provide the signals to control motion in all three dimensions.

In particular embodiments, the twin concepts of skyways, which have associated 3D motion constraint maps, and PCAM flight control work together to deliver a familiar user driving experience, which may be helpful for large-scale societal evolution of urban transportation into aerial pathways.

### Managing Urban Aerial Congestion and Air Traffic Control

In particular embodiments, just like terrestrial car drivers may self-manage their motion through routes permitted by the terrestrial road and freeway infrastructure, without a central authority such as central traffic control authorizing the permitted driving routes of cars, skyways may provide a natural extension of that concept for aerial movement and transportation. Drivers are familiar with the concept of roads and freeways and may self-manage their way through existing road and freeway infrastructures. By extending the notion of a terrestrial freeway and its associated driving experience into a virtual construct, the embodiments discussed herein may evolve the existing paradigm of self-management of traffic into aerial pathways. This may scale to hundreds of thousands of drivers in the skyway system, just as the paradigm of self-management of car traffic scales to hundreds of thousands of drivers on existing terrestrial roads and freeways. No real-time involvement of a central air traffic control function may be required either to generate permissible flight paths or to otherwise direct or manage real-time air traffic pathways inside the skyway system.

In particular embodiments, if a given set of skyways gets congested, urban planners may add new skyways. Adding new skyways may be a much simpler and cheaper process than building physical roads and freeways. Urban planners may create the appropriate 3D constraint map, ensuring its routes and connections satisfy safety, interconnection, traffic flow and congestion requirements, ensure the appropriate authorities digitally sign it and then securely distribute these new skyway maps to all authorized sky vehicles. In contrast, the cost of building physical bridges, roads and freeways is in the hundreds of millions if not billions of dollars. The cost of creating a skyway may include adding a virtual construct and securely distributing that to authorized sky vehicles. In other words, adding new skyways may be a relatively cost-free software managed update. This may potentially save billions of dollars in terms of constructing physical bridges, roads, and freeways in the future of the world.

A missing element for skyways, as described so far, is the visible aspects of a freeway, as the skyway construct is invisible and virtual and contained in the memory subsystems of the flight control computer of the sky vehicles and urban planner databases. In particular embodiments, techniques to help visualize the otherwise invisible and virtual construct that is a skyway may include skybots, as discussed below.

As shown in FIGS. 1-5, a skyway may connect to existing physical roads for transitioning on and off existing roads and freeways, and may connect to other skyways as well. This is entirely analogous to how the existing interconnected freeway system works. A sky vehicle may “drive” on a terrestrial road or freeway and then seamlessly take an on-ramp to a skyway and transparently be elevated or fly on the skyway. And at the appropriate time, the driver may take an off-ramp from the skyway and join a terrestrial freeway or road and continue driving it as a terrestrial car. In particular embodiments, a skyway is a shared virtual construct between all authorized sky vehicles. The same 3D constraint map may exist in the flight computers of all authorized sky vehicles just like roads and freeways are shared infrastructures and all drivers have the same perception of the road and freeway infrastructure. As such, the skyway may a long-lived construct inside the flight computers of sky vehicles and urban skyway planner databases, and not merely a temporary flight route for the autopilot function of a single sky vehicle on a single flight mission. Skyways may be created by urban planners, digitally signed by an appropriate authority responsible for that city or region's skyway infrastructure, and then securely communicated to all authorized sky vehicles. Their longevity in the urban landscape may be the same as that of existing terrestrial roads and freeways.

Skyways may be temporarily shut down in case weather related conditions make aerial transportation unsafe. For example, if an area is expected to experience a storm or a hurricane, making it unsafe to operate sky vehicles, urban planners and city authorities may shut the local skyways down, in essence making it impossible for a sky vehicle to be operating when it is unsafe to do so. As such, skyways may have many similarities to existing freeways and safety controls related to them.

Skyways may also be defined to permit only unidirectional motion, such that sky vehicles may only fly or move in a single permitted direction on the sky way, much like one-way roads and freeways function today. The sky vehicle's PCAM flight computer may enforce the movement constraints specified in the skyway map.

In particular embodiments, the sky vehicle (e.g., sky vehicle 203) may request, from an aerial-vehicle-transportation database, a driving map based on a three-dimensional representation of one or more transportation skyways, the three-dimensional representation comprising information regarding an x-axis and a y-axis representing movement in a first plane and information regarding a z-axis representing movement in a second plane perpendicular to the first plane. As discussed above and shown in at least FIG. 2, sky vehicle 203 may move along a plane determined by an x-axis 215 and a y-axis 217 (e.g., by the driver's direction), and also along a plane determined by z-axis 219 and perpendicular to the x-y plane (e.g., under PCAM flight control). The three-dimensional representation of one or more transportation skyways (e.g., three-dimensional map) and aerial-vehicle-transportation database may be stored, for example, by the PCAM flight computer or associated storage device.

The sky vehicle may then receive the driving map generated based on the information on the x-axis and the y-axis of movement, the driving map being determined based on the three-dimensional representation. As an example and not by way of limitation, as shown in FIG. 3, the sky vehicle (e.g., sky vehicle 203) may receive information on moving along third transportation lane 207 (e.g., the second skyway), or, as shown in FIG. 4, the sky vehicle (e.g., sky vehicle 203) moving along second transportation lane 205 (e.g., the first skyway).

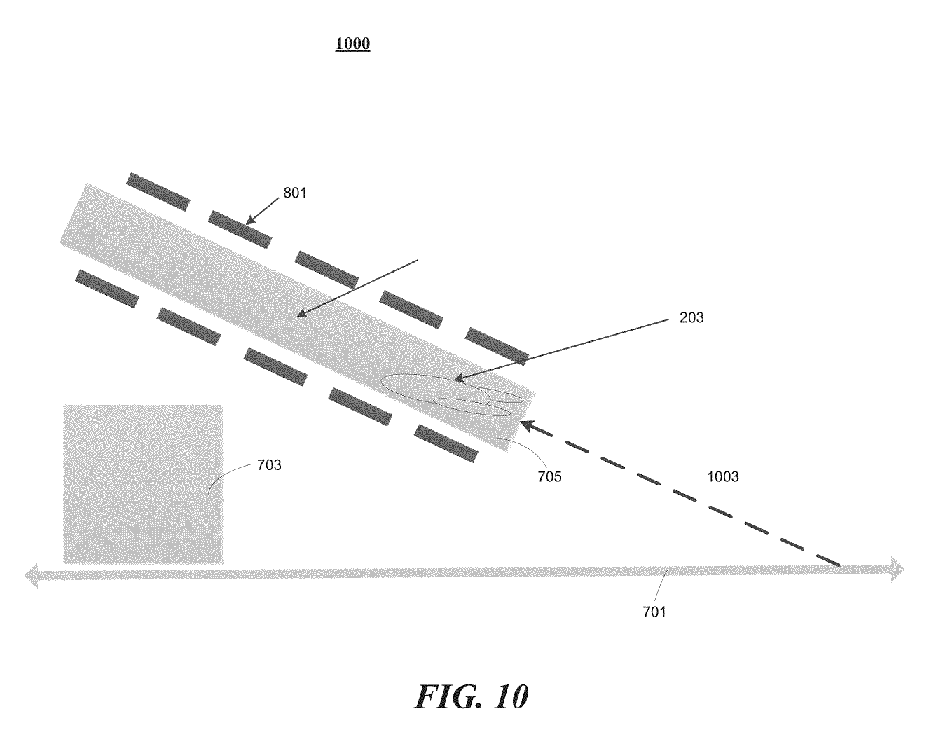

Then, the sky vehicle may receive information on altitude-transition zones associated with the z-axis of movement of the sky vehicle (e.g., aerial vehicle) along the second plane. The altitude-transition zone may include, for example, one or more skyshafts (e.g., FIG. 2 shows skyshafts 209, 211, and 213 for moving sky vehicles vertically down from a skyway, or vice versa), on-ramp/off-ramp (e.g., on-ramp/off-ramp as discussed below in relation to FIG. 10), other suitable altitude-transition zone, or any combination thereof. After receiving the information, the sky vehicle may store, in a navigation system of the aerial vehicle, navigation information comprising the driving map and the altitude-transition zones. In addition, the sky vehicle may display, on a user interface to a user controlling the movement of the sky vehicle, the two-dimensional driving map and altitude-transition zones associated with the z-axis of movement of the sky vehicle along the second plane. This information may be used by the driver in moving the sky vehicle on a terrestrial road or freeway, where the motion and maneuvering of the sky vehicle will be similar to that of a terrestrial vehicle.

In particular embodiments, the sky vehicle may then receive user input associated with controlling movement of the sky vehicle (e.g., to go in a particular direction, to go on a particular skyway, to maneuver to an altitude-transition zone, etc.), send instructions (e.g., to the sky vehicle computer and/or the PCAM flight computer) to steer the sky vehicle along the transportation skyways (e.g., along the x-y-axis and/or z-axis) based on the user input, and then display updates to the two-dimensional driving map based on the movement of the sky vehicle.

In particular embodiments, the first plane (i.e., representing movement along the plane represented by the x-axis and a y-axis) is substantially parallel to a surface of a planet. In particular embodiments, the controlling of the movements of the sky vehicle (e.g., along the x-y-axis and/or z-axis, and by the sky vehicle computer and/or the PCAM flight computer) comprises a movement along the first plane within the two-dimensional driving map. In particular embodiments, the instructions to move the sky vehicle along the transportation skyways further comprises instructions for automatically controlling the movement of the sky vehicle along the z-axis. In particular embodiments, the z-axis of movement is automatically controlled based on transportation information accessed via the sky-vehicle-transportation database, as discussed above.

In particular embodiments, the user input further comprises information associated with moving the sky vehicle along the z-axis within an altitude-transition zone of the altitude-transition zones to a specified location on the three-dimensional map. In particular embodiments, in response to the user input to move the sky vehicle along the z-axis, the PCAM flight computer sends instructions to the sky vehicle to move the sky vehicle within the altitude-transition zone to the specified location based on the user input.

In particular embodiments, sky vehicles may be linked with each other (e.g., via the PCAM flight computer) to optimize individual laminar flow and system-wide traffic flow. As an example and not by way of limitation, the sky vehicles may be linked up in row, geometric shape, or other suitable shape, to optimize individual laminar flow. In particular embodiments, sky vehicles may be linked to each other to form a group (e.g., a train, queue, squadron, cube, block, etc. of vehicles) to optimize individual and group laminar flow. In particular embodiments, the sky vehicles groups in this way may move in close proximity to each other and be coordinated (e.g., by the PCAM flight computer) to move as a single unit.

In particular embodiments, the sky vehicle (e.g., sky vehicle 203) may access, from an aerial-vehicle-transportation database, a three-dimensional map of one or more transportation skyways, the three-dimensional map comprising information regarding an x-axis and a y-axis representing movement in a first plane and information regarding a z-axis representing movement in a second plane perpendicular to the first plane, and then receive a two-dimensional driving map comprising the information on the x-axis and the y-axis of movement, the two-dimensional driving map determined based on converting the three-dimensional map of one or more transportation skyways into the two-dimensional driving map comprising the information on the x-axis and the y-axis of movement, as discussed above. Then, in particular embodiments, the sky vehicle may access, from the aerial-vehicle-transportation database, information comprising transportation information associated with all sky vehicles within a particular geographic location. Based on this information received from, for example, the PCAM flight computer, the sky vehicle may request update vehicle-movement constraint information based on the transportation information associated with all sky vehicles within the particular geographic location, and receive the vehicle-movement constraint information to determine how the sky vehicle should proceed.

In particular embodiments, the constraint information may include information on maintaining distances between sky vehicles, optimizing laminar flow, optimizing traffic flow, handling accidents, traffic incidents, and other diversions, autopilot functionalities, other functionalizes, or any combination there. In particular embodiments, the constraint information may be pushed from the PCAM flight computer to the sky vehicle, requested by the sky vehicle, or both, at predetermined time periods (e.g., once a hour, once a day, once a week, once a month, once a year, etc.).

In particular embodiments, the PCAM flight computer may receive, from a computing device associated with an sky vehicle, aerial vehicle travel information, and access from an aerial-vehicle-transportation database, a three-dimensional map of one or more transportation skyways, the three-dimensional map comprising information regarding an x-axis and a y-axis representing movement in a first plane and information regarding a z-axis representing movement in a second plane perpendicular to the first plane. Then, the PCAM flight computer may access from an aerial-vehicle-transportation database, information associated with traffic flow in a vicinity of the sky vehicle as determined based on the sky vehicle travel information associated with the sky vehicle, determine whether updated vehicle travel information should be sent to the sky vehicle based on the traffic flow information, and send the updated vehicle travel information for a particular geographic location when it is determined that updated travel information is to be sent to the sky vehicle.

In particular embodiments, the monitoring of traffic flow may include monitoring conditions including congestion, accidents, emergencies, other relevant situations, and any combination thereof. In particular embodiments, the determining of whether updated vehicle travel information should be sent to the aerial vehicle further includes sending recommendations/commands to take alternate route. In particular embodiments, the PCAM or the sky vehicle itself may automatically update the three-dimensional map based on updated vehicle information, updated vehicle travel information, other relevant information, or any combination thereof.

Although this disclosure describes partially-constrained sky vehicle motion and maneuvering/controlling sky vehicles in a particular manner, this disclosure contemplates partially-constrained sky vehicle motion and maneuvering/controlling sky vehicles in any suitable manner.

### Visible Skyways: Skybots and Floating Freeways of Light

In particular embodiments, in order to retain familiarity in terms of user and driver experience, a variety of both technical and sociological techniques are used to be able to visualize or “see” a skyway, much like drivers may see the physical roads and freeways they are driving on today. In particular embodiments, providing this visibility may be done at relatively low cost, as compared to the cost of constructing a physical freeway or bridge.

Skyways may be visualized using multiple techniques, which may be used independently or together. As an example and not by way of limitation, one technique may involve the use of mostly stationary drones in order to mark the boundaries of a skyway by hovering at a given set of side-barrier markers for the skyway. As discussed above, FIG. 6 illustrates an example three-dimensional urban area 600 with multiple aerial transportation lanes highlighted by skybots 601. As shown in FIG. 6, urban area 600 includes first transportation lane 201 at ground level (e.g., a terrestrial freeway lane) on which sky vehicles 203 may traverse along, buildings 202, second transportation lane 205 (e.g., the first skyway) at the first aerial level above ground level, and third transportation lane 207 (e.g., the second skyway) at the second aerial level above both the ground level and the first aerial level. In addition, FIG. 6 shows skyshafts 209, 211, and 213 for moving sky vehicles vertically down from a skyway. For example, skyshaft 209 may move sky vehicles 203 from second transportation lane 205 to first transportation lane 201 (or vice versa), skyshaft 211 may move sky vehicles 203 from third transportation lane 207 to second transportation lane 205 (or vice versa), and skyshaft 213 may move sky vehicles 203 from third transportation lane 207 onto the roof of building 202 (or vice versa). As an example and not by way of limitation, sky vehicle 203 may drive to and position itself on top or bottom of the virtual vertical drop location. The sky vehicle 203 may then descend vertically down such a designated “virtual shafts” and land on the rooftop (e.g., of building 202) or street parking or other designated landing spot. Similarly, the vehicle may fly vertically up such a vertical pathway from a rooftop parking lot and then join and fly onto the skyway. As shown in FIG. 6, sky vehicle 203 may move along a plane determined by x-axis 215 and y-axis 217 (e.g., by the driver's direction), and also along a plane determined by z-axis 219 and perpendicular to the x-y plane (e.g., under PCAM flight control). In addition, a set of autonomously piloted stationary drones 601 mark the entire length of the skyway system along the length of the virtual side barriers of the skyways. A possible technology for implementing the hovering drone is a specially programmed and equipped multi-rotor helicopter, e.g., a quad-copter.

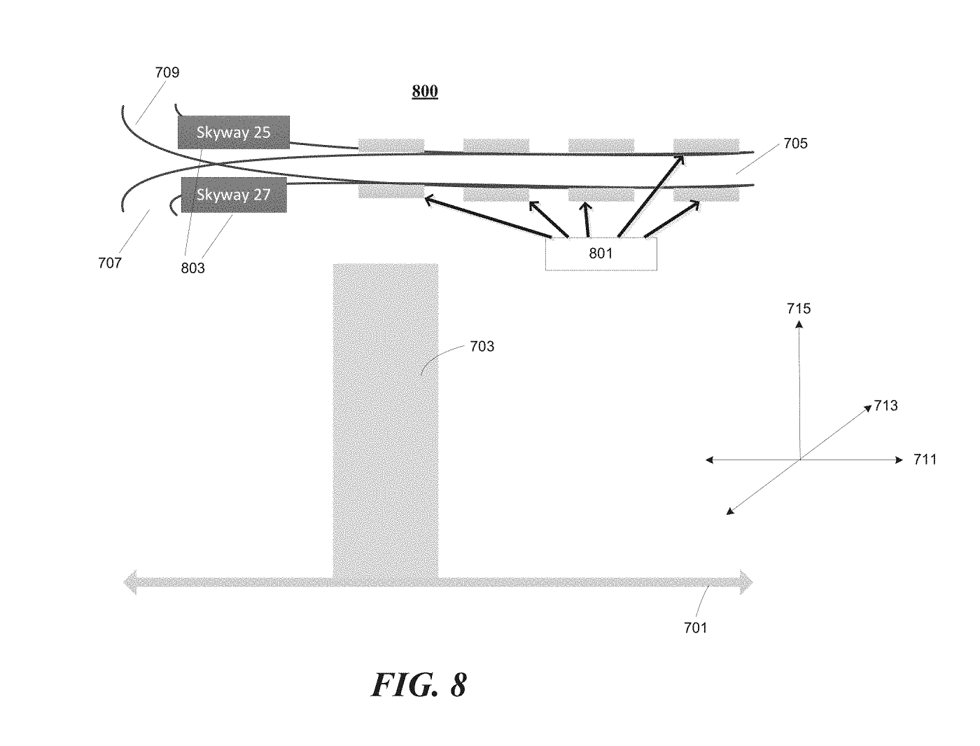

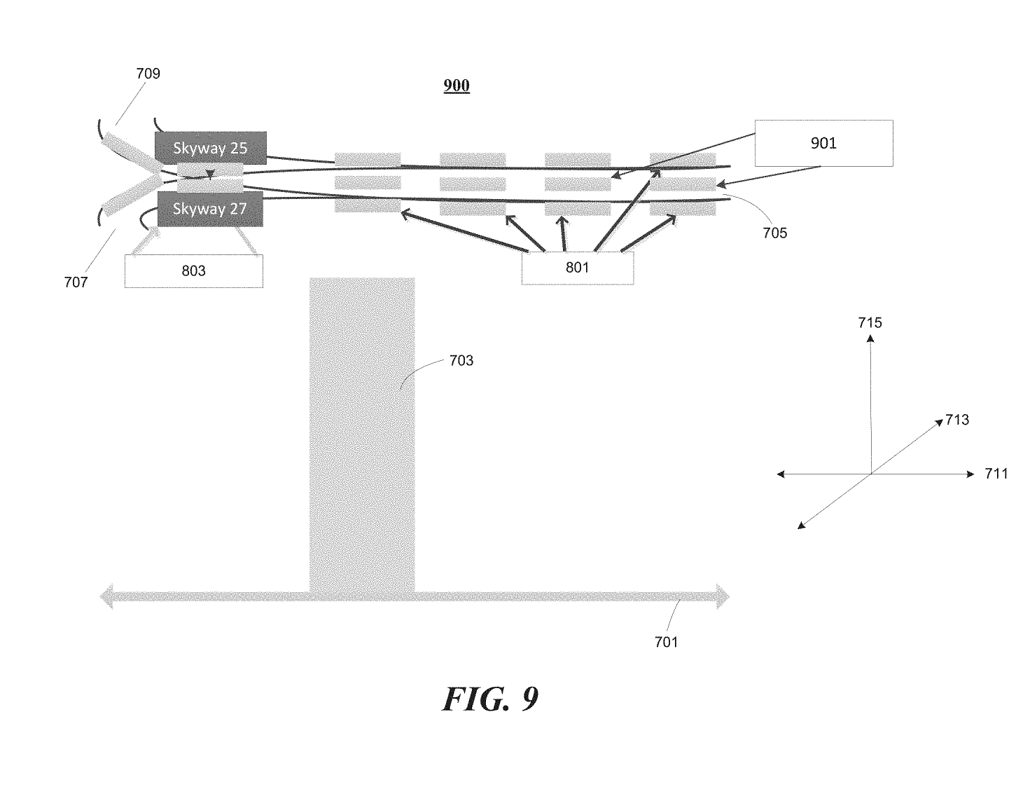

In particular embodiments, these specially programmed drones may be known as skybots. FIG. 8 illustrates an example three-dimensional urban area 800 with an example aerial transportation lane with skybots. FIG. 9 illustrates an example three-dimensional urban area 900 with an example aerial transportation lane with skybots 801 and skybot light beams 901. As shown in FIGS. 8 and 9, urban area 800/900 includes first transportation lane 701 at ground level (e.g., a terrestrial freeway lane) on which sky vehicles (e.g., sky vehicles 203) may traverse along, building 703, and second transportation lane 705 (e.g., the first skyway) at the first aerial level above ground level. As shown in FIGS. 8 and 9, second transportation lane 705 may split into two lanes to become third transportation lane 707 and fourth transportation lane 709. In addition, FIGS. 8 and 9 show that the sky vehicles (e.g., sky vehicle 203) may move along a plane determined by x-axis 711 and y-axis 713 (e.g., by the driver's direction), and also along a plane determined by z-axis 715 and perpendicular to the x-y plane (e.g., under PCAM flight control). Moreover, FIG. 8 shows skybots 801 positioned along the perimeter of second transportation lane 705 (e.g., the first skyway) to mark the entire length of the skyway system. FIG. 8 also shows signs 803 for display to the driver of sky vehicle 203. As an example and not by way of limitation, signs 803 may include road signs, skyway signs, advertisements, etc. FIG. 9 shows a plurality of skybot light beams 901, which may be a combination of skybots emitting light across the skyway to skybots on the other side, and/or to skybots on the same side of the skyway to mark the length of the skyway on one side.

A skybot position map may be created that marks various skybot locations along the side barriers of a given skyway. The locations are virtual skybot markers that may be inhabited by a set of physical drones that change over time. Skybot control software sends a number of skybots to each of the marked locations along the skyway system. As a given skybot needs recharging or refueling, another skybot is dispatched to the same virtual marker, and the first skybot flies back on autopilot to a designated charging location. This makes it a semi-permanent and software maintained and managed infrastructure where a network of skybots autonomously helps to mark the virtual corridors of a skyway. FIGS. 8 and 9 illustrate a skyway marked by these skybots, and also skybots that may hold a display sign showing the different directions of the skyway as it splits.

In particular embodiments, at nighttime, or during poor visibility or fog conditions, the same drones may light up and transmit light to each other as either discrete bands or a fully covered “light carpet”, in effect creating a floating freeway of light. This may bring to complete visual reality the virtual object that is a skyway. As discussed above, these light beams may be a combination of skybots emitting light across the skyway to skybots on the other side, and/or to skybots on the same side of the skyway to mark the length of the skyway on one side. As an example and not by way of limitation, it may be easier for drivers to direct themselves towards and drive and stay on top of a skyway and take intersection ramps to other skyways, because the skybots and floating freeway of light provide the visual indicators, direction and boundaries of the skyways and their interconnections and on/off-ramps.

In particular embodiments, skybots may also be used to display skyway intersection signs to other skyways and destinations along the path of the skyways, much like freeway signs perform these functions as shown above. In particular embodiments, skybots may also be used to display commercial messages, much like commercial billboards exist on terrestrial roads and freeways. These commercial messages may help subsidize the operational costs of maintaining the skyways and skybots. Various kinds of displays may be mounted on the side-barrier skybots, or special display skybots may hover at the appropriate spot alongside or above the skyways. A visible and floating freeway of light is another way to maintain familiarity of user and driver experience, which may be helpful for a mass societal evolution to an urban transportation system that may be different than what people and society are accustomed to today.

In particular embodiments, another technique to visually indicate a skyway involves displaying the skyway as an image of a terrestrial freeway, either on a display panel inside the sky vehicle or on a translucent windshield and windows of the sky vehicle, assuming it has a windshield and windows. The skyway visual element in the display may be shown in translucent color or some other visual technique may be used to differentiate it from a physical freeway shown in the same display.

In particular embodiments, a 3D graphics computer may perform real-time rendering, based on the location of the sky vehicle relative to the skyway and other sky vehicles, physical freeways and buildings, by fusing together images of the virtual and physical objects into a single display. In particular embodiments, this may be similar to the 3D visualization of first-person augmented reality software where a display is rendered for the user, using elements from both the physical world and virtual elements, creating the illusion of seeing elements that exist only virtually, alongside physical world objects. When displaying on the vehicle's windshield, the display software would intelligently take physical world objects such as other vehicles, freeways, skyways, buildings etc. and create a realistic composite 3D image on the windshield reflecting the real objects and the virtual object in a single display. As with skybots, freeway signage for skyway numbers and guidance to various destinations may also be projected inside the augmented reality composite virtual/real-world display.

In particular embodiments, use of skybots and floating freeways of light, internal display panel first-person skyway maps and augmented reality displays using composite digital world and real world visualization techniques are not mutually exclusive, and may be used in conjunction with each other.

In particular embodiments, the PCAM flight computer may control the skybots to mark skyway paths by receiving, from an aerial-vehicle-transportation database, a three-dimensional map of one or more transportation skyways, the three-dimensional map comprising information regarding an x-axis and a y-axis representing movement in a first plane and information regarding a z-axis representing movement in a second plane perpendicular to the first plane, determining a plurality of locations along the one or more transportation skyways for placing a plurality of location markers to delineate the one or more transportation skyways, and sending instructions to position one or more location markers at each of the plurality of locations along the one or more transportation skyways.

In particular embodiments, the skybots may be deployed by the PCAM flight computer to mark and/or light paths (e.g., skyways), which may include illuminating pathway based on time of day or amount of light. In particular embodiments, the skybots may be deployed by the PCAM flight computer to control traffic flow, which may include a vehicle authentication function, a vehicle map and/or software verification function, other relevant functions, or any combination thereof. In particular embodiments, the skybots may be deployed by the PCAM flight computer to monitor weather and/or road conditions. In particular embodiments, the skybots may be deployed by the PCAM flight computer for recharging/refueling functions. In particular embodiments, the skybots may be deployed by the PCAM flight computer for advertisement/message functionalities (e.g., as shown by signs 803 of FIG. 8, which include road signs, skyway signs, advertisements, etc.). In particular embodiments the skybots may be deployed by the PCAM flight computer to control and/or maneuver traffic based on colors (e.g., red for stop, green for go, etc.), and in such instance, traffics lights, stop lights, and other traffic signals may not be necessary. In particular embodiments, the skybots may be deployed by the PCAM flight computer may be solar powered, energy efficient, use other natural energy sources, or any combination thereof.

Although this disclosure describes controlling and maneuvering skybots in a particular manner, this disclosure contemplates controlling and maneuvering skybots in any suitable manner.

### Example of a Person Driving on a Skyway

A sky vehicle may be moving on a terrestrial road or freeway, where its motion may be similar to that of a terrestrial vehicle, being guided by driver input using accelerator and brake pedals and a steering wheel. In this terrestrial driving mode, motion may be enabled by a combination of tires being controlled by an electrical motor, not unlike how existing electrical vehicles are operated today. In addition, the skyways may be interconnected to terrestrial roads in the 3D map of the flight computer, and visually illustrated by one or more of the techniques described above.

FIG. 10 illustrates an example three-dimensional urban area 1000 with an example aerial transportation vehicle moving on an aerial transportation lane with skybots. As shown in FIG. 10, urban area 1000 includes first transportation lane 701 at ground level (e.g., a terrestrial freeway lane) on which sky vehicles (e.g., sky vehicles 203) may traverse along, building 703, and second transportation lane 705 (e.g., the first skyway) at the first aerial level above ground level. FIG. 10 also shows skybots 801 positioned along the perimeter of second transportation lane 705 (e.g., the first skyway) to mark the entire length of the skyway system. In addition, FIG. 10 shows that sky vehicle 203 may start off moving along first transportation lane 701 at ground level and then elevate (e.g., via an on-ramp/off-ramp 1003) to second transportation lane 705 (e.g., the first skyway) at the first aerial level above ground level. Discussed below is an example of how the sky vehicle's flight computer may use the skyway 3D map in order to control and manage flight motion of a sky vehicle.

When the driver takes an “on-ramp” (e.g., on-ramp 1003) to a skyway connected to the road he or she is driving, the PCAM flight computer may automatically and rapidly calculate (and recalculate) where the forward motion of the vehicle is going to take the vehicle based on the 2D driver input. In particular embodiments, the PCAM flight control may continuously calculate the height or elevation of the skyway at the projected future position, and automatically and transparently add elevation thrust to the sky vehicles aerial motions systems to the driver, such that when the vehicle reaches the projected point, its elevation is automatically increased to the position and orientation indicated in the skyway's 3D map. This process may continue as long as the driver is driving on top of the virtual skyway infrastructure.

In particular embodiments, if the projected forward position of the vehicle will take the vehicle to a place on the skyway map where the virtual elevation is lower, the flight computer may automatically send signals to sky vehicle propulsion system to lower the elevation of the vehicle.

During this entire period, the driver's input using the accelerator and brake and the steering wheel is 2D only, signaling the forward acceleration or deceleration and left/right movements of the vehicle. From a driver's perspective, he or she is simply driving the same way as he or she would on a terrestrial freeway or road. The flight computer may transparently combine the input from the 3D skyway map and the user's 2D driving input and calculate the converged 3D output to the sky vehicle's aerial motion systems using PCAM flight control software.

Once the vehicle is airborne, and at a predefined height above physical ground level, its tires may automatically retract into the frame of the sky vehicle.

By rapidly sampling the driver's input, which may change in real-time, for example, due to application of the accelerator or the brakes on the sky vehicle, the flight computer may be able to adjust and readjust the output of the sky vehicle's flight propulsion systems to always maintain the illusion of “driving” directly on top of and within the skyway system and not deviating from the prescribed elevations and spatial 3D constraints of the skyways.

If the skyway “descends” and “joins” a terrestrial road or freeway, at specially designated physical freeway/virtual skyway interconnection points (e.g., as shown in with on-ramp/off-ramp 1003 in FIG. 10), the tires will automatically descend at an appropriate earlier point prior to making ground contact, and when contact is made with the terrestrial road, the tire motion control system will automatically take over the motion control of the vehicle and the vehicle will start operating again like a traditional terrestrial electrical vehicle.

### Skyshafts

In particular embodiments, there are places where it may be advantageous to have a sky vehicle drop vertically down onto a location from a skyway or rise vertically up from a location to a skyway. Example uses of these might be parking spots on building rooftops or parking or landing spots on traditional physical streets.

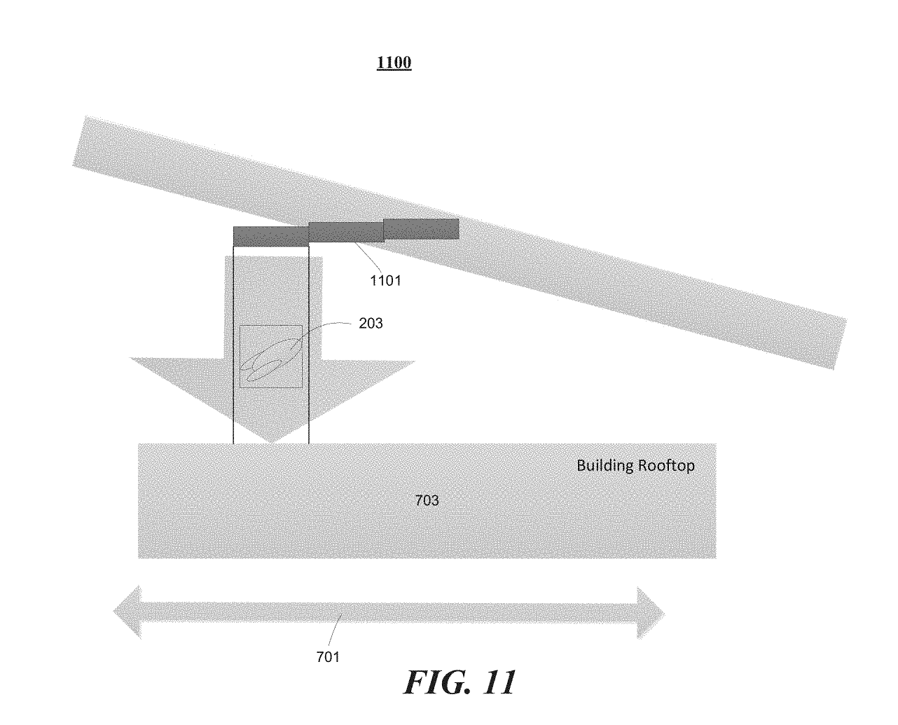

In particular embodiments, a virtual vertical shaft may be accessed using specially marked locations on or alongside a skyway. As an example and not by way of limitation, such specially marked locations on the skyway map may be known as skyshafts, which permit completely vertical downwards or upwards motion of sky vehicles from and to various skyways and landing or transit locations. FIG. 11 illustrates an example three-dimensional urban area 1100 with an example skyshaft 1101 for moving aerial vehicles from a skyway to a building top. As shown in FIG. 11, urban area 1100 includes first transportation lane 701 at ground level (e.g., a terrestrial freeway lane) on which sky vehicles (e.g., sky vehicles 203) may traverse along, building 703, and second transportation lane 705 (e.g., the first skyway) at the first aerial level above ground level. FIG. 11 also shows skybots 801 positioned along the perimeter of second transportation lane 705 (e.g., the first skyway) to mark the entire length of the skyway system. In particular, FIG. 11 shows a rectangular skyshaft 1101, adjacent to second transportation lane 705 (e.g., the first skyway), and leading to the rooftop of building 703, which could be used as a charging and/or parking spot. In addition, for the sky vehicle to fly vertically down the sky shaft and then move into a vacant parking stall on the rooftop, the planar surface of the rooftop of the building may also be part of the 3D motion constraint map of the sky vehicle. FIG. 2 illustrates an example three-dimensional urban area with multiple aerial transportation lanes and vehicles, and also illustrates three skyshafts for moving sky vehicles vertically down from a skyway. As an example and not by way of limitation, FIG. 2 shows that skyshaft 209 may move sky vehicles 203 from second transportation lane 205 to first transportation lane 201 (or vice versa), skyshaft 211 may move sky vehicles 203 from third transportation lane 207 to second transportation lane 205 (or vice versa), and skyshaft 213 may move sky vehicles 203 from third transportation lane 207 onto the roof of building 202 (or vice versa). As discussed above, as an example and not by way of limitation, a sky vehicle may drive to and position itself on top or bottom of the virtual vertical drop location. The sky vehicle may then descend vertically down such a designated “virtual shafts” and land on the rooftop or street parking or other designated landing spot. Similarly, the vehicle may fly vertically up such a vertical pathway from a rooftop parking lot and then join and fly onto the skyway. As an example and not by way of limitation, if a skyway is analogous to a freeway in the physical world, then the analogy in the physical world to a (virtual) sky shaft is a physical car elevator shaft.

In particular embodiments, much as skyways may be visualized using light emitting skybots, a skyshaft may be made visible as a column of vertical light beams cast by a set of hovering skybots, which are stationed on the boundaries of the skyshaft, e.g. by using downward-facing light emitters mounted on the hovering skybots or ground based lights marking the location of the skyshaft, pointing vertically up or both. It may also be visually indicated in the sky vehicle's internal control/display panel, which displays skyways as well.

In particular embodiments, an additional use of skyshafts might be to vertically connect two different skyways. If two different highways intersect in 2D space, but not in the vertical dimension, then they could be connected by a skyshaft allowing cars to travel vertically up or down the skyshaft from one skyway to another.

In particular embodiments, since completely vertical up/down motion may not be part of a car's standard control apparatus, there may be special control elements, for example, on the control/display panel inside the sky vehicle, which would visually indicate when the vehicle is at the top or bottom of a skyshaft. The sky vehicle may sense when its location is coincident with a skyshaft, and this would enable vertical movement controls inside the sky vehicle. The driver could then press an up/down button on the control panel, which would instruct the sky vehicle to automatically take the sky vehicle either up or down the skyshaft at a safe speed.

In particular embodiments, there may be unidirectional skyshafts, one for upwards movement and another for downwards movement, in order to avoid the possibility of two different sky vehicles going in opposite directions in the same skyshaft at the same time, risking a collision inside the skyshaft. And there could be skyshafts with multiple levels for entry and exit, such that one would simply press the level number, and the sky vehicle would automatically ascend or descend to that level. As an example and not by way of limitation, this may be the case for a multi-level rooftop parking structure.

### Tires Optional

If there is adequate electrical storage energy, a sky vehicle may be in flight mode even while driving on top of a traditional terrestrial road, elevated a small distance above the terrestrial road. In particular embodiments, the entire map of existing terrestrial roads and freeways may be added to the skyway maps. The skyway elevation may calculated as being at a certain height above the terrestrial road or freeway's elevation with a few feet (e.g., 2-3 feet) added to the physical world height of the road or freeway. This enables motion control on terrestrial roads and (aerial) skyways to work in exactly the same way, with no physical transition in the motion control system from aerial flight control systems to traditional car tires and an electrical motor tire control system.

In particular embodiments, sky vehicles may not require tires. They only fly, sometimes a few feet above existing terrestrial roads and freeways, and sometimes a few hundred feet above ground, as indicated by the elevation of the skyway the sky vehicle is driving on. This converged physical and virtual road/skyway map may allow sky vehicles to easily fly a few feet above the ground, over existing roads and freeway, and therefore drive into existing homes and buildings and their parking garages, or use terrestrial road street-side parking.

### Sideways Motion

Considering the extreme flexibility of the sky vehicle, nothing constrains the vehicle from going vertically up and down, as described above, or completely sideways left/right. As an example and not by way of limitation, sideways motion may be useful for parking into a tight spot, where the car simply aligns itself with the opening on the street and moves directly sideways into the open parking spot.

In particular embodiments, pure left/right controls may be available for special purpose use cases. An example motion control system that is simple for an average person to understand and use is a lever or software implemented control panel object, that may be moved vertically up/down or horizontally left/right to indicate the desired motion trajectory, assuming that such motion is permissible within the constraints of the 3D motion constraint map. And in these use cases, the software will know that a positioning up/down or left/right is required, and will automatically move the vehicle in the indicated direction into the appropriate spot.

### Aligning the Vehicle Along an Angled or Slanted Skyway

In particular embodiments, just like a physical freeway may be angled or slanted as it is going up or down in height, similarly a skyway map may have additional 3D descriptions in it to indicate the angled or slanted nature of the skyway. The flight propulsion system will transparently ensure that the frame or chassis of the vehicle is aligned with the complete 3D description of the skyway, including an angled or slanted skyway, as the vehicle travels along the skyway.

### Air Turbulence and Air Currents

Air turbulence may occur unexpectedly. For airplanes, air turbulence may not be easily visible to either the pilots or the plane's electronic systems therefore it is difficult in traditional airplane flight control systems to take this as an additional input in order to counteract it. And a traditional commercial jet airplane's motion control system (using jet engines mounted on the wings or the tail) may not have an arbitrary direction thrust vectoring system that may be employed to counteract the unpredictable forces of air turbulence either.

In particular embodiments, if there is air turbulence that jostle the skybots around, the skybots' flight computer may record these and generate counter-balancing propulsion control system output in order to enable the skybots to remain in their stationary position. The skybot network may communicate the real-time turbulence vectors in their respective vicinities (via short range or long range wireless communications) to all sky vehicles driving on the skyway they are acting as visual markers for. In particular embodiments, the network of skybots may act as forward scouts for air turbulence. Since the sky vehicle's flight computer now knows of turbulence before it is encountered, it may calculate the counter-balancing outputs to the flight propulsion system to cancel out the motion effects of the air turbulence when it encounters it, thereby providing smooth and bump-free flight motion even through pockets of air turbulence. By leveraging the network of skybots along a skyway as forward scouts of air turbulence, it changes turbulence from an unexpected to an expected phenomenon. In particular embodiments, the aerial thrust system of the sky vehicle is fairly general, and may generate arbitrary thrust vectors in 3D in order to cancel the disruptive forces of air turbulence which are arbitrary 3D turbulence generated forces.

In particular embodiments, a sky vehicle may receive real-time information about air currents from the network of skybots and create new thrust vectors that cancel them out, in order to hover in place or drive smoothly on an aerial path as intended by the driver without being unduly shaken or blown off course by an unexpected air current or air turbulence.

In particular embodiments skybots may annotate the skyway map with real-time information regarding air currents or turbulence and relay these to all sky vehicles in close proximity, which would then use this information in order to pre-compute the air turbulence cancellation thrusts. By exchanging this information rapidly, for example, multiple times per second, the skybot network may ensure that sky vehicles may take timely action to cancel out the flight disturbance forces.

### Design Requirements of Sky Vehicles

Now, that we have described the Sky Machines architecture and design to be based on a mostly 2D driver supplied input and a 3D motion constraint map consisting of skyways, marked and illuminated by skybots, with PCAM flight control software providing transparent 3D flight control along the varying elevations of the skyway, we discuss the high level requirements and design details of the sky vehicles themselves.

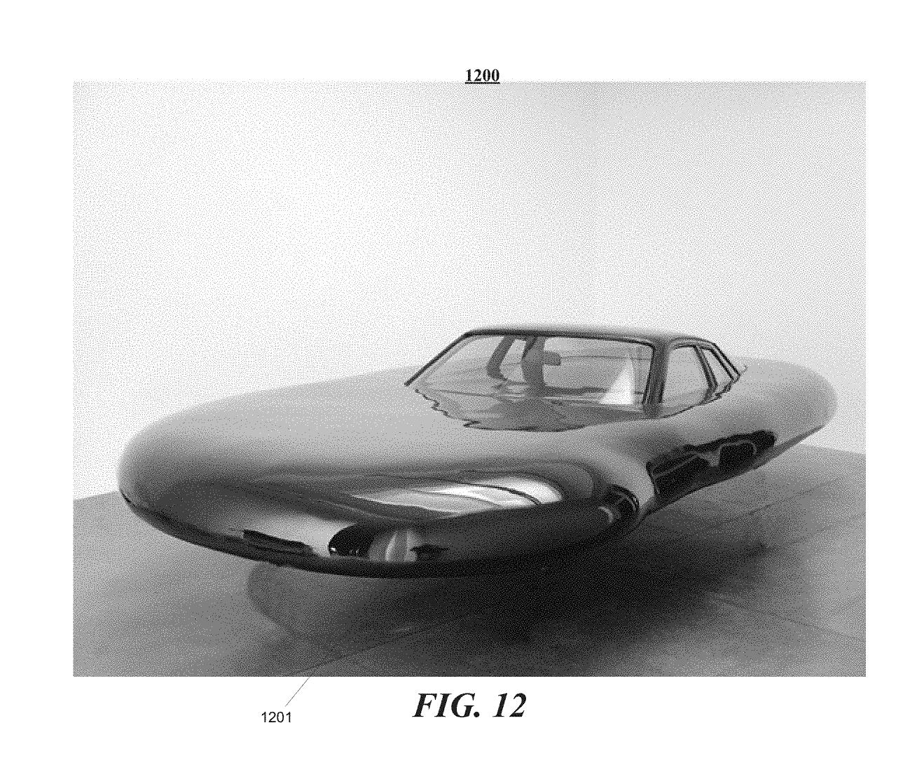

FIG. 12 illustrates an example aerial transportation vehicle 1200. In particular embodiments, an aerial vehicle accepts terrestrial vehicle-like 2D driving input from the driver. As an example and not by way of limitation, the sky vehicle may have the familiar driving controls of a car, for a sky vehicle that is designed to resemble a car. These include but are not limited to, a steering wheel, an accelerator pedal, a brake pedal, and forward/reverse gears, a console to display the merged freeway/skyway map and current position of the vehicle in the map, etc. The controls may also include a lever (hand or foot accessible) or internal display/control panel software enabled button that may be pushed up/down and sideways left/right for some of the special cases noted in this document, related to completely vertical movements e.g. or on skyshafts and completely sideways movements e.g. for street side parking scenarios. In particular embodiments, the output of these controls is provided to a flight computer that computes the rest of the 3D information from the skyway 3D constraint map database or other relevant information received in real-time such as air turbulence vectors.

In particular embodiments, an example aerial transportation vehicle may include a sky bike that may include motion control devices would be the same as that on a traditional motorbike, for example a two armed handle, accelerator control in one of the handles, a brake control handlebar in another etc. This may also include a hand or foot accessible lever or control panel display button for up/down movement control.

In particular embodiments, since precise and very flexible aerial motion control is required, including the ability to stop or hover in place, or move backwards, and the need to move vertically up/down and sideways, the design may include using a rotary wing or a traditional fixed-wing airplane structures. As an example and not by way of limitation, the rotary wing structure may include a quad-rotor design, because the aerial motion achieved may be very precise, flexible and stable, and permits simple forward/reverse, up/down including completely vertical up/down, and left/right controls including completely sideways left/right motion capabilities. This design may also permit the motion control system to generate arbitrary 3D thrust vectors, for example to cancel out the disruptive effects of air turbulence or to maintain precise PCAM flight control.

In particular embodiments, an aerial vehicle may include a requirement for fault tolerance for safety reasons, and include passenger and population safety as a prime consideration. Failure of a single or even multiple mechanical or electrical or software components should not result in a crash of the vehicle.

In particular embodiments, this safety requirement may involve the need for an array of quad-rotors integrated into a vehicle's chassis and working together as a fault-tolerant ensemble, which may be referred to as the sky vehicle's skyframe 1201.

The skyframe 1201 may include an integrated and internally redundant electrical energy storage system. Failure of a single quad-rotor assembly or electrical storage element does not cause a Sky Vehicle to fail or crash. By building a redundant array of quad-rotors, integrated together both mechanically and via software, and working together as a fault tolerant ensemble, failure resilience may be an important part of the design of the sky vehicles.

In particular embodiments, the skyframe chassis includes an array of quad-rotors providing lift and control from the bottom of the skyframe's chassis, air intakes from the sides and front/back of the vehicle, and an electrical energy storage system, using banks of batteries or fuel cells, mounted on top of the quad-rotors. The driver and passenger seating structures, for example in a car-like cabin, may mounted on top of the skyframe.

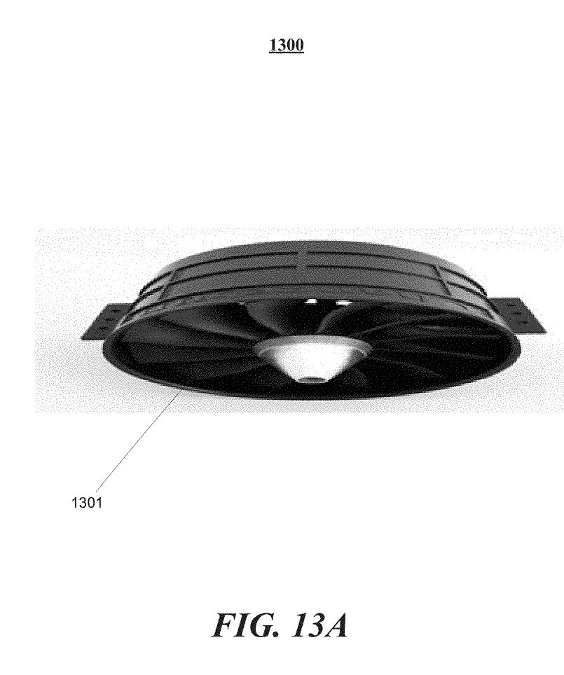

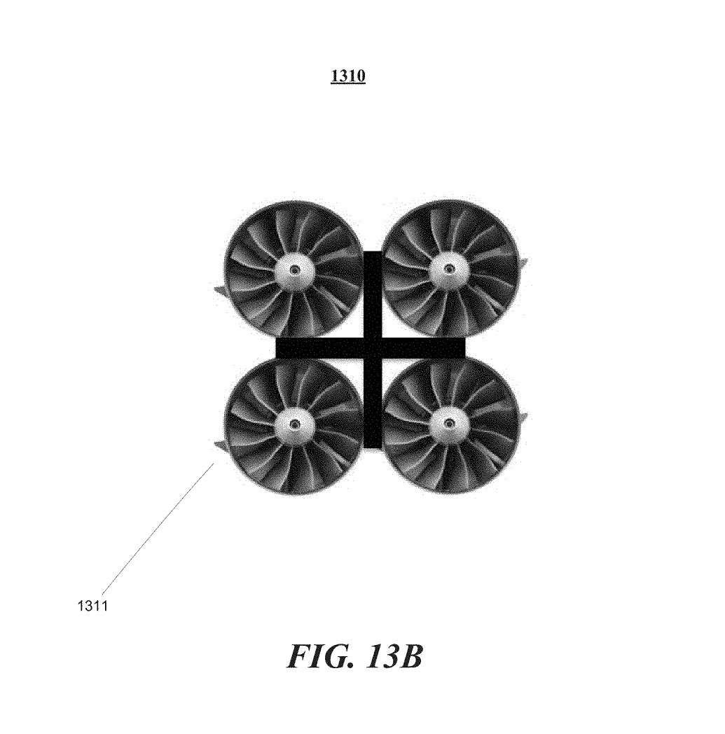

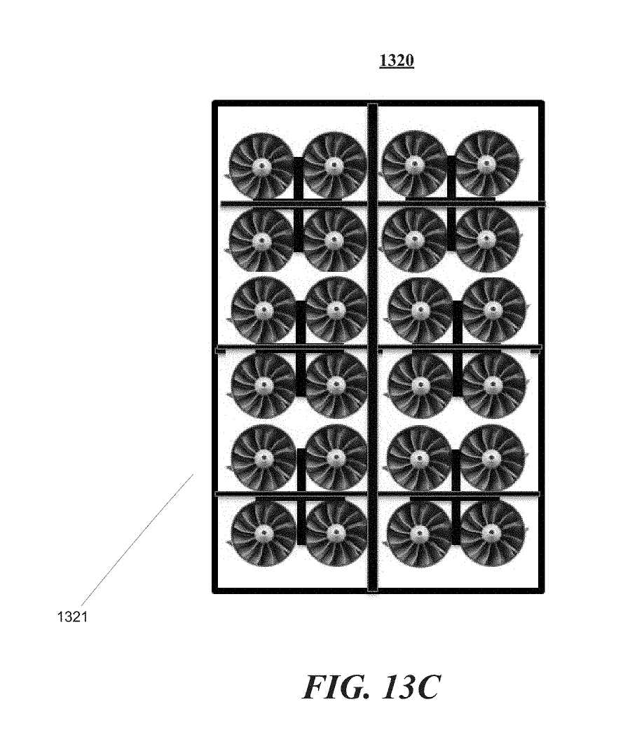

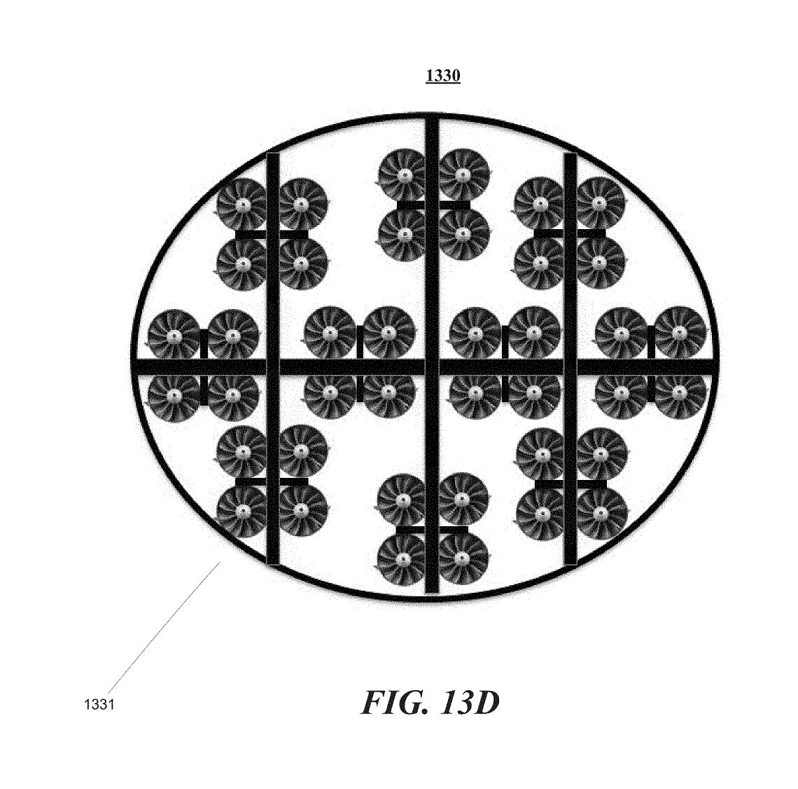

FIG. 13A illustrates a rotor assembly 1300 for an aerial transportation vehicle. FIG. 13A shows a side view of a ducted high thrust single rotor 1301. FIG. 13B illustrates another embodiment of a rotor assembly 1310 for an aerial transportation vehicle. FIG. 13B shows a bottom-up view of a ducted high thrust quad-rotor assembly 1311. FIG. 13C illustrates a third embodiment of a rotor assembly 1320 for an aerial transportation vehicle. FIG. 13C shows an example rectangular skyframe, composed of an array of quad-rotors all integrated together into a single rectangular metal frame chassis 1321. FIG. 13D illustrates a fourth embodiment of a rotor assembly 1330 for an aerial transportation vehicle. FIG. 13D shows an example elliptical skyframe, composed of an array of quad-rotors all integrated together into a single elliptical metal frame chassis 1331. The geometric arrangement above is intended to be illustrative of how an array of quad-rotors may be integrated to form a rectangular skyframe. Many other shapes and designs are possible by putting the quad-rotors in different geometric layouts. As an example and not by way of limitation, FIG. 13D shows an elliptical shaped skyframe, which may be useful as a floating platform, or a special purpose sky vehicle.

In particular embodiments, a ducted fan quad-rotor configuration may be used, which may help improve efficiency of thrust and to also minimize cross-array quad-rotor interference due to rotor fan-tip air current turbulences and vortices that may unpredictably affect the performance of neighboring quad-rotors in the array. In particular embodiments, an open set of quad-rotor fans may be used.

In particular embodiments, the heavy lift needs of sky vehicles require high thrust rotor assemblies within each quad-rotor array element. An example of such a high thrust single rotor assembly is a ducted rotor with a large number (e.g. 10-20) of high-pitch fan blades.

In particular embodiments, the relative width and pitch of rotor fan blades, number of quad-rotors per assembly, inter-quad-rotor spacing and other aspects of geometry and proportion will vary based on the different needs and requirements of the sky vehicles. And strong lightweight materials may be used everywhere in the design, including the rotor blades, and cabin construction material. An example of such a strong and lightweight material is carbon fiber.

In particular embodiments, the inner quad-rotor elements may need air ducting routed to them from the external intake vents, in order to prevent airflow starvation for inner elements of the quad-rotor array. And there may be single-rotor structures at the front and back and along the sides in order to implement fast braking, maintaining motion within PCAM constraints, and fast acceleration.

In particular embodiments, many different kinds of skyframes are possible, including but not limited to what would be similar to the chassis of a car, a skyframe to create a sky-bike, which would resemble a flying jet ski and with similar driver controls, a skyframe to accommodate a van or a bus, etc. Different kinds of passenger cabin designs and structures may be mounted on top of the skyframe, which would allow a fair amount of flexibility in the design and visual aesthetics of sky vehicles as these would likely evolve over time, as design choices and aesthetic preferences change in the marketplace.

In particular embodiments, the electrical power supply of sky vehicles mounted on top of the quad-rotor array in the skyframe may include, but are not limited to, chemical batteries (e.g., Li-Ion), Fuel Cells (e.g., Hydrogen fuel cells) and compressed air tubes. In particular embodiments, electrical storage may include high energy density (kwh/kg and kwh/cubic meter) at an affordable cost. As an example and not by way of limitation, this may include electrical storage that is high in energy (kwh) with minimal associated volume and weight. In particular embodiments, climate change sensitivity may be important, so non-carbon emitting and clean sources may be preferable over those that add to global greenhouse gasses.

In particular embodiments, the quad-rotor array may have sufficient lift per square foot in the skyframe to carry both the skyframe and the anticipated payload on the skyframe (e.g., sky vehicle cabin and the drivers and passengers and their belongings riding in it).

In particular embodiments, a skyframe may have a redundant set of skyframe controllers that are responsible for interfacing with the main PCAM flight controller. The skyframe controller set takes the flight control signals from the main flight computer and dispatches appropriate signals to each quad-rotor in the quad-rotor array. The skyframe controller takes the desired 3D position, including orientation and elevation, and desired motion from the main PCAM flight computer. It may then compute the relevant sub-inputs for each element in the quad-rotor array, and signals each one to move to its 3D position and provide the necessary sub-thrust vectors necessary for the aggregate motion of the skyframe itself.

In particular embodiments, there are fault and failure detection and recovery software mechanisms in the skyframe controller set, which would detect the failure of one or more quad-rotors and signal that to the remaining quad-rotors so they may adjust their thrusts to compensate for the loss of motion thrust from the failed quad-rotors. As an example and not by way of limitation, in the face of partial failures of quad-rotor assemblies, the skyframe controller signals the remaining functional quad-rotors to adapt their thrust vectors to compensate for the failed elements. The redundant skyframe controllers may also recover from failure of hardware or software elements in a given skyframe controller itself, such that failure of a single skyframe controller doesn't result in a failure of the skyframe itself.

In particular embodiments, the efficiency of air thrust of a rotor increases for larger rotor radii, but a larger rotor radius also means a larger unit of failure, should something go wrong with a given quad-rotor assembly. So, there may be a trade-off between efficiency of air thrust and fault-tolerance of the skyframe in the face of one or more quad-rotor failures. In particular embodiments, a rotor radius size that doesn't completely sacrifice one aspect, e.g., fault tolerance, for another, e.g., efficiency of achieving air thrust, may be selected. In particular embodiments, a quad-rotor array may have precise controllability, agility, and flexibility to move in any direction including front/back and left/right, ability to hover or stop in mid-air, and the inherent resilience to failures an array of quad-rotors provides.

In particular embodiments, by making the entire quad-rotor array structure less visible and not extending out from the sky-vehicles frame gives the vehicle tremendous advantages when being “driven” or flown on traditional roads or freeways, in close proximity with existing terrestrial vehicles or other sky vehicles, or when being parked in the garages of existing homes and buildings which have the constraints of existing cars' physical dimensions.

In particular embodiments, the skyframe is a software controllable structure, with enough lift and motion thrust to accommodate the various anticipated loads on top of the skyframe. And the PCAM flight control software treats the entire ensemble as a single integrated system, sending it the appropriate commands for the various directions and speeds of the desired aerial motion.

As discussed above, FIG. 12 illustrates an example aerial transportation vehicle, which is visually and physically consistent with the design requirements of a sky car, as described above. This concept image of a vehicle is a suitable visual and physical design for the sky car's driver and passenger cabin. The skyframe, not shown above, would have the electrical storage system and the array of quad-rotors, and it would be mounted beneath the cabin, which is illustrated above. There are no extensible fixed wings or externally visible helicopter rotors. And there are no tires in this design either; the vehicle would simply lower a set of steel legs or regular rubber tire or other suitable platform element when it is to be parked.

This image is only an example visual concept image. In particular embodiments. an sky car design may include significantly more front/back and side air intake ducts to satisfy the air intake requirements for the quad-rotor array propulsion mechanisms. There may also be greater height of the cabin-mounting frame to accommodate the batteries and the quad-rotor array. The doors may be operable to permit people to enter and exit the car and there may be headlights and sidelights.

In particular embodiments, given the general extensibility of a skyframe, and many possible cabin structures, many different kinds of sky vehicles may be designed, including but not limited to, single person sky cars, single person sky bikes, 2-5 person sky cars, 8-10 multi-person transportation vehicles eg sky buses etc. And these use cases may be for traditional transportation or bringing to life fantasy games and sports use cases, some of which are described later in this document.

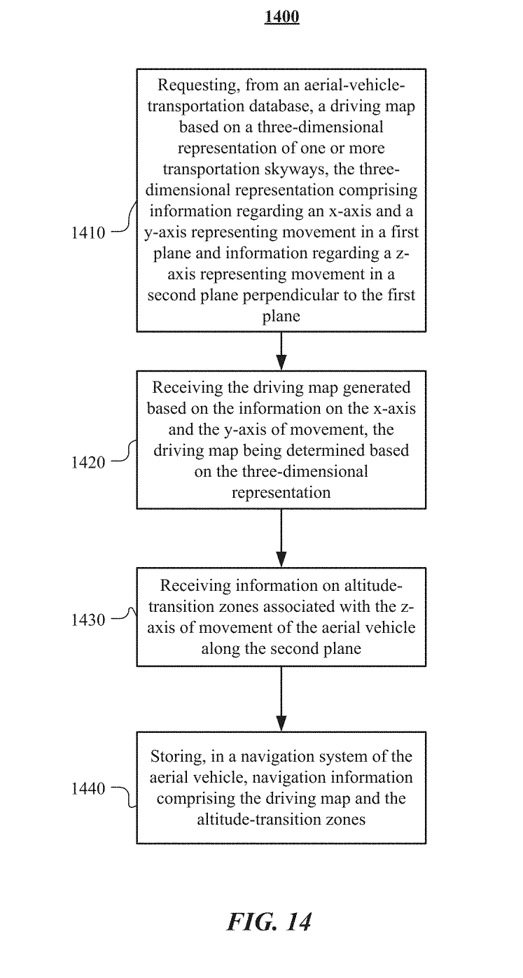

FIG. 14 illustrates an example method for accessing and displaying a three-dimensional map of transportation skyways. The method (e.g., by a computing device associated with an aerial vehicle) may begin at step 1410, where the computing device may request, from an aerial-vehicle-transportation database, a driving map based on a three-dimensional representation of one or more transportation skyways, the three-dimensional representation comprising information regarding an x-axis and a y-axis representing movement in a first plane and information regarding a z-axis representing movement in a second plane perpendicular to the first plane. At step 1420, the computing device may receive the driving map generated based on the information on the x-axis and the y-axis of movement, the driving map being determined based on the three-dimensional representation. At step 1430, the computing device may receive information on altitude-transition zones associated with the z-axis of movement of the aerial vehicle along the second plane. At step 1440, the computing device may store, in a navigation system of the aerial vehicle, navigation information comprising the driving map and the altitude-transition zones. In particular embodiment, the computing device may display, on a user interface to a user controlling the movement of the aerial vehicle, the two-dimensional driving map and the altitude-transition zones. Particular embodiments may repeat one or more steps of the method of FIG. 14, where appropriate. Although this disclosure describes and illustrates particular steps of the method of FIG. 14 as occurring in a particular order, this disclosure contemplates any suitable steps of the method of FIG. 14 occurring in any suitable order. Moreover, although this disclosure describes and illustrates an example method for using transportation skyways including the particular steps of the method of FIG. 14, this disclosure contemplates any suitable method for using transportation skyways including any suitable steps, which may include all, some, or none of the steps of the method of FIG. 14, where appropriate. Furthermore, although this disclosure describes and illustrates particular components, devices, or systems carrying out particular steps of the method of FIG. 14, this disclosure contemplates any suitable combination of any suitable components, devices, or systems carrying out any suitable steps of the method of FIG. 14.

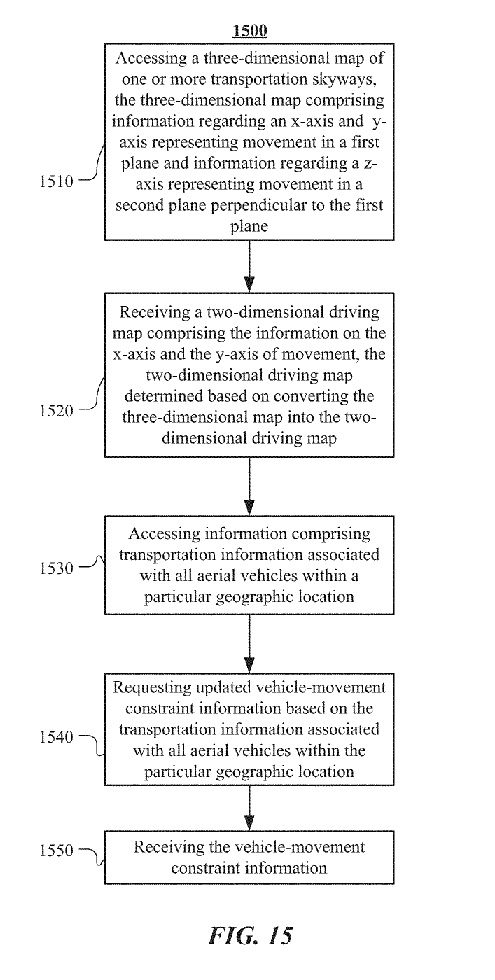

FIG. 15 illustrates an example method for navigating an aerial vehicle on the three-dimensional map of transportation skyways. The method (e.g., by a computing device associated with an aerial vehicle) may begin at step 1510, where the computing device may access, from an aerial-vehicle-transportation database, a three-dimensional map of one or more transportation skyways, the three-dimensional map comprising information regarding an x-axis and a y-axis representing movement in a first plane and information regarding a z-axis representing movement in a second plane perpendicular to the first plane. At step 1520, the computing device may receive a two-dimensional driving map comprising the information on the x-axis and the y-axis of movement, the two-dimensional driving map determined based on converting the three-dimensional map of one or more transportation skyways into the two-dimensional driving map comprising the information on the x-axis and the y-axis of movement. At step 1530, the computing device may access, from the aerial-vehicle-transportation database, information comprising transportation information associated with all aerial vehicles within a particular geographic location. At step 1540, the computing device may request updated vehicle-movement constraint information based on the transportation information associated with all aerial vehicles within the particular geographic location. At step 1550, the computing device may receive the vehicle-movement constraint information. Particular embodiments may repeat one or more steps of the method of FIG. 15, where appropriate. Although this disclosure describes and illustrates particular steps of the method of FIG. 15 as occurring in a particular order, this disclosure contemplates any suitable steps of the method of FIG. 15 occurring in any suitable order. Moreover, although this disclosure describes and illustrates an example method for navigating an aerial vehicle on the three-dimensional map of transportation skyways including the particular steps of the method of FIG. 15, this disclosure contemplates any suitable method for navigating an aerial vehicle on the three-dimensional map of transportation skyways including any suitable steps, which may include all, some, or none of the steps of the method of FIG. 15, where appropriate. Furthermore, although this disclosure describes and illustrates particular components, devices, or systems carrying out particular steps of the method of FIG. 15, this disclosure contemplates any suitable combination of any suitable components, devices, or systems carrying out any suitable steps of the method of FIG. 15.

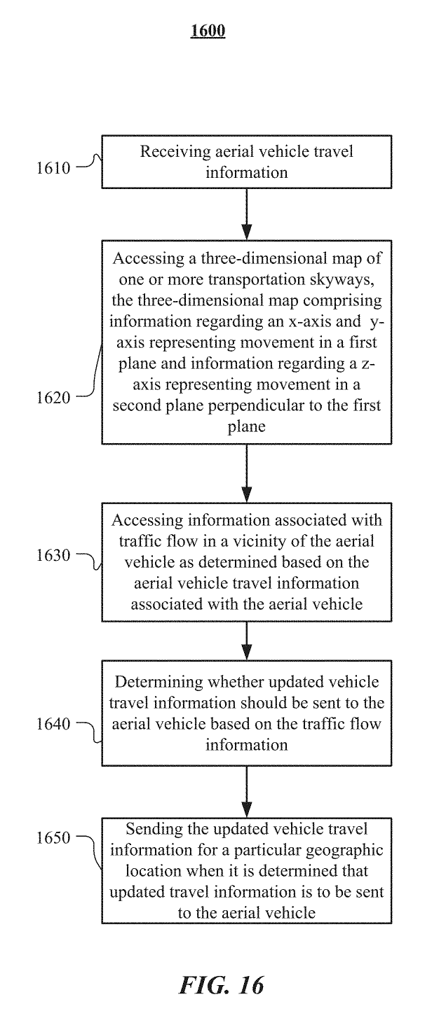

FIG. 16 illustrates an example method of sending updated vehicle travel information for a particular geographic location. The method (e.g., by a server device associated with an aerial vehicle control system) may begin at step 1610, where the server device may receive, from a computing device associated with an aerial vehicle, aerial vehicle travel information. At step 1620, the server device may access, from an aerial-vehicle-transportation database, a three-dimensional map of one or more transportation skyways, the three-dimensional map comprising information regarding an x-axis and a y-axis representing movement in a first plane and information regarding a z-axis representing movement in a second plane perpendicular to the first plane. At step 1630, the server device may access, from an aerial-vehicle-transportation database, information associated with traffic flow in a vicinity of the aerial vehicle as determined based on the aerial vehicle travel information associated with the aerial vehicle. At step 1640, the server device may determine whether updated vehicle travel information should be sent to the aerial vehicle based on the traffic flow information. At step 1650, the server device may send the updated vehicle travel information for a particular geographic location when it is determined that updated travel information is to be sent to the aerial vehicle. Particular embodiments may repeat one or more steps of the method of FIG. 16, where appropriate. Although this disclosure describes and illustrates particular steps of the method of FIG. 16 as occurring in a particular order, this disclosure contemplates any suitable steps of the method of FIG. 16 occurring in any suitable order. Moreover, although this disclosure describes and illustrates an example method for sending updated vehicle travel information for a particular geographic location including the particular steps of the method of FIG. 16, this disclosure contemplates any suitable method for sending updated vehicle travel information for a particular geographic location including any suitable steps, which may include all, some, or none of the steps of the method of FIG. 16, where appropriate. Furthermore, although this disclosure describes and illustrates particular components, devices, or systems carrying out particular steps of the method of FIG. 16, this disclosure contemplates any suitable combination of any suitable components, devices, or systems carrying out any suitable steps of the method of FIG. 16.

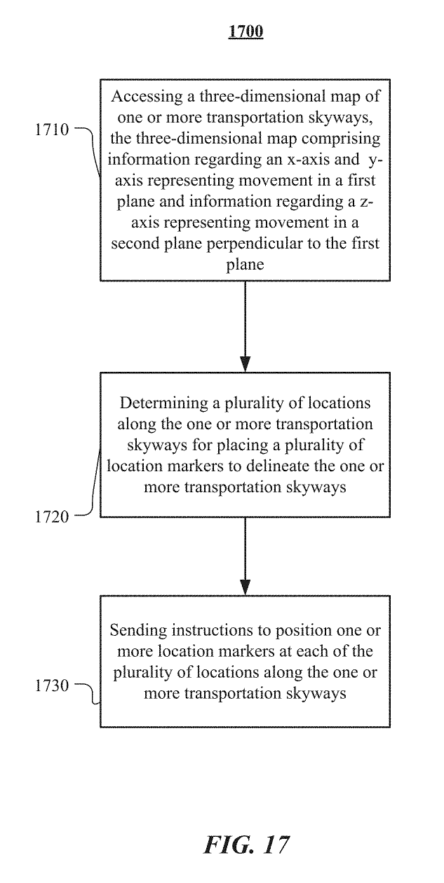

FIG. 17 illustrates an example method of controlling a plurality of location markers via a centralized control system. The method (e.g., by a server device associated with an aerial vehicle control system) may begin at step 1710, where the server device may receive, from an aerial-vehicle-transportation database, a three-dimensional map of one or more transportation skyways, the three-dimensional map comprising information regarding an x-axis and a y-axis representing movement in a first plane and information regarding a z-axis representing movement in a second plane perpendicular to the first plane. At step 1720, the server device may determine a plurality of locations along the one or more transportation skyways for placing a plurality of location markers to delineate the one or more transportation skyways. At step 1430, the server device may send instructions to position one or more location markers at each of the plurality of locations along the one or more transportation skyways. Particular embodiments may repeat one or more steps of the method of FIG. 17, where appropriate. Although this disclosure describes and illustrates particular steps of the method of FIG. 17 as occurring in a particular order, this disclosure contemplates any suitable steps of the method of FIG. 17 occurring in any suitable order. Moreover, although this disclosure describes and illustrates an example method for controlling a plurality of location markers via a centralized control system including the particular steps of the method of FIG. 17, this disclosure contemplates any suitable method for controlling a plurality of location markers via a centralized control system including any suitable steps, which may include all, some, or none of the steps of the method of FIG. 17, where appropriate. Furthermore, although this disclosure describes and illustrates particular components, devices, or systems carrying out particular steps of the method of FIG. 17, this disclosure contemplates any suitable combination of any suitable components, devices, or systems carrying out any suitable steps of the method of FIG. 17.

Securing Sky Machines from Cyber Attacks

In particular embodiments, any cyber-physical construct, which is what the Sky Machines architecture represents, has to be resilient to all forms of software and hardware subversion and cyber attacks, such that violations or subversion of PCAM flight control system, malicious alteration of the skyway maps, or other malicious ways to create collisions or crashes are not possible.

In particular embodiments, the base layer of all computing elements, which are the PCAM flight control software and the skyframe controllers, may comprise a formally verified and formally secured hypervisor layer of software. Such a software construct may be inherently immune to cyber attacks, as it has been shown to be free from the kinds of software defects cyber attacks rely upon. And such a construct may also help secure software modules (e.g., hypervisor processes) running on top of the formally verified hypervisor. As long as the sky vehicles are running these formally verified pieces of hypervisor and hypervisor process software, a cyber attack on the sky vehicle will not be feasible. And receiving a digitally signed skymap or skymap updates ensures that the skyways have not been maliciously altered such that they create collisions or crash possibilities in the aerial pathways.

In particular embodiments, such a software construct, in conjunction with appropriate system level hardware controls, such as Trusted Platform Module (TPM), and Trusted Execution Technology (TXT) and secure boot, may ensure that only secure software that has not been maliciously altered is running on all the compute elements of the sky vehicle and skybots. Because secure boot using TXT and TPM may allow remote attestation of the integrity of the software, skybots that line the skyways, will have the opportunity to remotely determine whether the sky vehicle hardware and software has not been maliciously altered.

In particular embodiments, skybots may challenge all sky vehicles as they enter the skyway to prove that they are running only formally secured software platform, and that the underlying hardware and software has not been maliciously altered to permit a physical or cyber-physical attack. A sky vehicle will respond with codes that attest to the integrity of the hardware and software stack, and these codes will verifiable by the skybots. Thus the skybots also act as virtual gatekeepers of the skyways. If a valid attestation code is not provided, access to the skyway may be limited, for example, by not opening a physical gate leading to the skyway or by alerting sky police that a non-conforming and potentially subverted sky vehicle is attempting to access the skyway system.

As an example and not by way of limitation, another form of cyber attack on the sky machine architecture is to forge the GPS satellite signals in order to attempt to make the sky vehicle software believe it is at a different location than it actually is. Or altogether block the GPS signals by signal jamming or other mechanisms with the goal to not allow a sky vehicle to accurately determine its position and thereby enable a cyber-physical attack. In particular embodiments, sky vehicles will have multiple mechanisms to guard against any kind of GPS location forgery or entire loss of GPS signal. First, sky vehicles will not rely solely on GPS information to determine present location. They will use multiple internal inertial guidance sensors to determine present location, and if there is a significant discrepancy or loss of GPS location information, they will resort to the information provided by internal inertial guidance sensors. Additionally, sky vehicles will use neighboring skybots to acquire location information, over local area wireless networks, and this will serve as an additional safeguard in case of either loss of accuracy or outright denial of GPS information. This will also help guard against the inherent location drift of inertial guidance sensors. Skybots will use secure communication channels to convey their location (and therefore indirectly a sky vehicle's location) information, making them not susceptible to a location forgery or denial of information attack.

In particular embodiments, skybots will similarly use a combination of GPS information, internal inertial guidance sensor information, neighboring skybots and radio signal information from close by cellphone towers as multiple different ways to compute their precise location, with each technique compensating for an attack or potential loss or degradation of quality of the other techniques of location information.

### Mass Adoption Challenges

Discussed below are ways each of the challenges related to mass urban scale adoption noted above have been dealt with by the Sky Machines design and integrated architecture.

### Drivability

Since user experience and required driver skill sets in order to operate an aerial vehicle was a primary consideration, particular embodiments explicitly deals with this by providing a familiar 2D terrestrial vehicle control system, as well as overall driving experience. Using the physical controls of a steering wheel, forward/reverse gears, accelerator and brake pedal, and visualizing skyways as floating freeways of light, particular embodiments provide as familiar an aerial driving experience as is possible for people used to driving cars on physical roads and freeways today.

### Air Traffic Control at Urban Population Scale

This is a prime and up-front design consideration. Air traffic control here is similar to the self-management of terrestrial traffic control in existing freeways and roads. On ramps and off ramps allow vehicles to interconnect between terrestrial roads and freeways and virtual skyways. Other than the technology combination of PCAM flight control and the associated skyway virtual/physical infrastructure, no new innovation is required in the form a massively scalable central air traffic control system.

### Vehicle Occupant and Ground Population Security and Safety Issues

Hundreds of thousands of flying objects in a spatially constrained urban environment clearly pose a safety hazard from crashes or operator errors or vehicle failures resulting in vehicles falling from the sky. The system architecture and vehicle design of particular embodiments mitigate these safety issues in multiple ways.

First, the partial aerial constraint maps or skyways create order in what would otherwise be a chaotic and unconstrained aerial environment, preventing free-form flight in urban skies, along with the possibility of aerial collisions and crashes. No central air traffic control system is likely to scale to millions of aerial vehicles and the Sky Machines architecture doesn't rely on it. Sky vehicle drivers self-manage their paths on skyways, similar to how they self-manage their paths on freeways today. And with PCAM flight control it is not possible to intentionally crash a plane, either on the ground or on some building or structure.

Second, the ease of use and familiar user and driver experience allows us to leverage the common car driving skills that millions of ordinary people already have. Lots of people cannot be expected to be expert pilots. By not requiring expert piloting skills, particular embodiments have dramatically reduced the potential safety hazards in urban skies. A simpler to operate vehicle is inherently safer than one that has complex operational controls as it reduces the chances of operator error. As mentioned above, the likelihood of a mother on the way back from doing grocery shopping, with children crying in the back, to make some form of operator error is quite high when using an aerial vehicle that has the operational complexity of an airplane. However, since the operational complexity of a sky vehicle is approximately the same as the operational complexity of a terrestrial car, the chances of making operator errors in these two cases are roughly the same. And in most cases, due to PCAM flight control, the chances that the operator error will result in, for example, running off the skyway or some other undesirable event are eliminated, as the PCAM flight control software enforces spatial constraints on the movements of the sky vehicle which are designed with safety in mind. This makes sky vehicles safer than even traditional cars, in this respect.

Third, by integrating physical and virtual freeways seamlessly, as described above, it is possible to stipulate that sky vehicles fly at only at very low heights above the ground, e.g. a few feet, in areas where it is not desirable for the ground population to have over flights of a large number of aerial vehicles, e.g. in dense residential neighborhoods. In these cases sky vehicle safety considerations are not different from cars driving around in the same neighborhoods.

Fourth, there may be well-defined corridors or shafts that allow sky vehicles to vertically travel to and from existing roads and parking lots, using the concept of skyshafts, again providing order in what otherwise would be an unconstrained chaos of aerial movements with the associated safety hazards, for aerial vehicles to descend or ascend from existing roads or rooftops.

Fifth, by using redundant arrays of quad-rotors, controlled by redundant and fault tolerant skyframe controller architecture, particular embodiments inherently provide fault tolerance in the aerial motion control and software design of the sky vehicle's architecture. Occupant and ground population safety is greatly enhanced, as the system is tolerant to the failures of a single or even multiple mechanical, electrical or software components of the sky vehicle, for example, quad-rotors or battery elements or skyframe controllers.

Sixth, particular embodiments explicitly address the issue of urban terrorism using bomb-laden aerial vehicles to fly into high value buildings or targets. The Sky Machines architecture eliminates this possibility as the vehicle is constrained to stay inside (or on top of) the digitally signed and pre-defined skyway map, and skyways will be designed by urban planners to not be close to high value buildings or monuments or permit a sky vehicle to be flown into them.

Lastly, by using formally verified software, which is inherently secure from cyber attack, in all the key compute and control elements of the sky vehicle, particular embodiments minimize the possibility of a cyber attack on a sky vehicle. And by doing remote attestation of hardware and software integrity via challenge/response systems implemented in gatekeeper skybots particular embodiments minimize the possibility that a threat actor group has subverted a given Sky Vehicle compute platform, either hardware or software, in order to enable a physical or cyber-physical attack. By stipulating digital signatures for skyway maps and skyway map updates, particular embodiments have eliminated the possibility of malicious alteration of skymaps. Particular embodiments also have described multiple ways to guard against location information forgery or denial of location information attacks.

### Alternate Uses of Sky Vehicles

Discussed below are some use cases of PCAM flight control, using different kinds of 3D motion constraint maps, different than the use case of providing an infrastructure for mass aerial urban transportation.

### SkyTracks for Racing Sky Vehicles

Sky Vehicles, and different kinds of motion constraint maps, may be used to bring to life certain kinds of fantasy games, some of which have been seen in science fiction or fantasy movies.

Just like a skyway is analogous to a freeway, particular embodiments include a 3D motion constraint map to describe a floating racetrack. An example of a fictional sports game that may be brought to life is the Star Wars inspired racing game of Speeder Bikes, where the speeder bikes are special single user sky bikes constrained to fly on a specially constructed sky racetrack.

The 3D partial-motion constraint map keeps the game riders and vehicles in a safe place with respect to visitors and game audience and onlookers and preventing crashes into audience stalls. As an example and not by way of limitation, such specially crafted 3D constraint maps used for sports purposes may be referred to a skytracks. An example of a skytrack could be a special purpose set of skyways inside a sporting stadium, for example, in a football field or existing car or motorbike racing track, either in closed or open loop geometric form.

There are several choices in how skytracks may be constructed for different sports variants. As an example and not by way of limitation, there could be non-intersecting and concentric skytracks, such that the sky vehicle's paths are not allowed to intersect, eliminating the possibility of a mid-air bump or collision, but still permitting a close proximity multi-player racing look and feel. As another example, there could be a single skytrack wide enough to accommodate multiple sky cars or sky bikes on it, such that bumps and collisions are possible for the aerial racing vehicles, and potentially a part of the sport in terms of gaining an advantage in the race. The audience stalls may be excluded from the 3D motion constraint map.

A skytrack may be constructed in a confined area, for example, a football field, and the range and payload lift requirements for racing sky bikes is much less than the range and payload requirements of general purpose transportation uses. As an example and not by way of limitation, it may require much less regulatory approvals, since it would only operate in a contained area, possibly in a private property and flights will not take place over the general population. And, the technological challenges of high capacity and lightweight electrical storage are much less burdensome for short range racing use cases than for longer range intra-city transportation use cases.

SkyDome with Virtual Safety Net

The second fantasy sports use case example is to create a multi-player sport, where aerial vehicles fly inside a constrained 3D surface such as a spherically topped virtual sky dome. The bottom of the surface would be flat and a few feet above the ground, in order to provide a virtual “safety net” for vehicles inside the SkyDome.

An example of a fantasy sport would be a technology-enabled version of the fictional competitive sport Quidditch, made famous in the popular fantasy books based on the fictional character of Harry Potter. Instead of magical brooms, one would have riders on sky vehicles that resemble sky bikes.

And unlike the previous example of skyways and skytracks, game-playing users will be able to provide real-time up/down input in addition to right/left and front/back. However, the PCAM flight computer may still constrain the motion of the sky bikes to stay inside the 3D structure, such that it does not fly outside the top of the virtual sky dome and does not fall or fly below the virtual safety net, potentially hitting or crashing into the ground, the virtual flat bottom of a spherical top virtual structure.

For a sky bike used in the context of a SkyDome, there would need to be additional controls for up/down movement. This could be implemented using an up/down motion control lever mounted at the foot level of the bike. These could essentially be the same driving controls as a conventional motorbike, with the addition of an up/down motion control lever at the driver's foot level.

Specially programmed skybots may be designed, equipped and configured to perform the role of the various floating objects and flying balls in the game, e.g., the Quaffle, the Bludger and the Golden Snitch.

In other words, we may use the concept of PCAM flight control to not only create skyways for mass urban transportation, skytracks that resemble racing tracks, but we may use the same concept to create a completely different 3D motion constraint structures, such as a virtual sky dome and a virtual safety net, for use cases such as creating new forms of fantasy sports using special purpose sky vehicles and skybots.

### Special-Use Skyways for Emergency Vehicles

In particular embodiments, there may be special-use skyways that would exist only for specially authorized vehicles, such as those belonging to police or ambulances providing emergency services. These would be separate from general public use skyways, and will only allow specially authorized sky vehicles to operate on these skyways. There may be skyshafts interconnecting special use skyways to general use skyways, as and where needed. As an example and not by way of limitation, a set of use cases for sky vehicles will be for delivering police, medical and other emergency services and enabling a new class of fantasy aerial sports as described above.

### Military and Law Enforcement Uses of Sky Vehicles

In particular embodiments, there may be both military and intelligence use cases of sky vehicles. Such specially equipped sky vehicles will take input from military special operation planners, such that not just skyways, but vast sky planes (large planar surfaces) may be constructed to allow for mission flexibility in terms of flying to and from military or intelligence target locations. Sky planes are special 3D constraint maps that allow the mission planners to create a vast planar flight surface dipping and rising as the need arises. Some of these Sky planes or mission-specific 3D constraint maps could be purely temporary, as they may involve regions or countries that don't have a public skyway system.

And as in the case of the fantasy game example above, it is also possible to provide free-form 3D aerial movement for specially equipped and configured military use sky vehicles.

In particular embodiments, there may be certain kinds of sky vehicles used in indoor environments for both law enforcement and military special operations use cases. In these environments, mission planners may use the internal architecture of the building as a blueprint to construct a special 3D constraint map that allows an indoor sky vehicle, e.g., a sky bike, to fly inside the building and also fly up and down stairs and elevator shafts. Law enforcement or special operations teams may fly inside the building, without worrying about colliding into the walls or ceilings or into the stairwell, because the 3D constraint map will create safe aerial paths inside the building by using the locations of wall, ceilings, doors and stairs' elevations and locations as an input to create an aerial pathway 3D constraint map for the interior of the building.

Military and law enforcement personnel operating these vehicles may then fly inside the building, potentially even at high speeds, without worrying about collisions with internal building structures, and stay focused on the specifics of their missions without having to deal with flight safety issues.

Mission planners would also have the ability to design and build a temporary set of skyways that would last for the duration of the mission only. Such missions could extend into regions and countries that do not have official skyways, and therefore these would be specially created for the purposes of the military or intelligence mission.

### Foot Operated Full 3D Motion Control Sky Bikes

For certain kinds of vehicles, e.g., the military or sports use case sky bikes discussed above, it may be advantageous to provide a foot operated lever for up/down and left/right motion control, providing completely hands-free operation for flight motion control. As mentioned in the Quidditch example, a virtual sky-dome or other kinds of constraint maps may permit more flexible 3D user input in the vertical dimension than would be possible on a regular skyway map, and therefore these controls will provide a very easy to understand and operate set of 3D motion controls, and in some of these cases, completely hands-free control as well. The driver's hands could be used for holding weapons. Or they could be used to grab the golden snitch or other flying elements as needed for that class of aerial sports, as in the example of the game of Quidditch using skybots in place of the magical flying balls.

### Self-Driving Sky Vehicles

In particular embodiments, self-driving car technology may a natural fit for use on sky vehicles, as self-driving cars' control systems are designed for 2D motion and terrestrial roads, as they exist today. By extending the concept of roads into aerial pathways, self-driving car technology may also be easily extended into aerial pathways, providing the same benefits of unattended driving with crash avoidance and collision resistance as it is provided to self-driving terrestrial cars today.

A self-driving car is consistent with the paradigm of self-management of traffic in congested environments, as each car independently manages its own routes and motion based on real-time sensing of the surrounding environment along its planned routes. As such, this is a distributed congestion and driving control system. This is markedly different than a central air traffic control system dispatching unique flight routes to various aerial vehicles based on centralized knowledge and assumptions about the availability of those routes.

### Systems and Methods

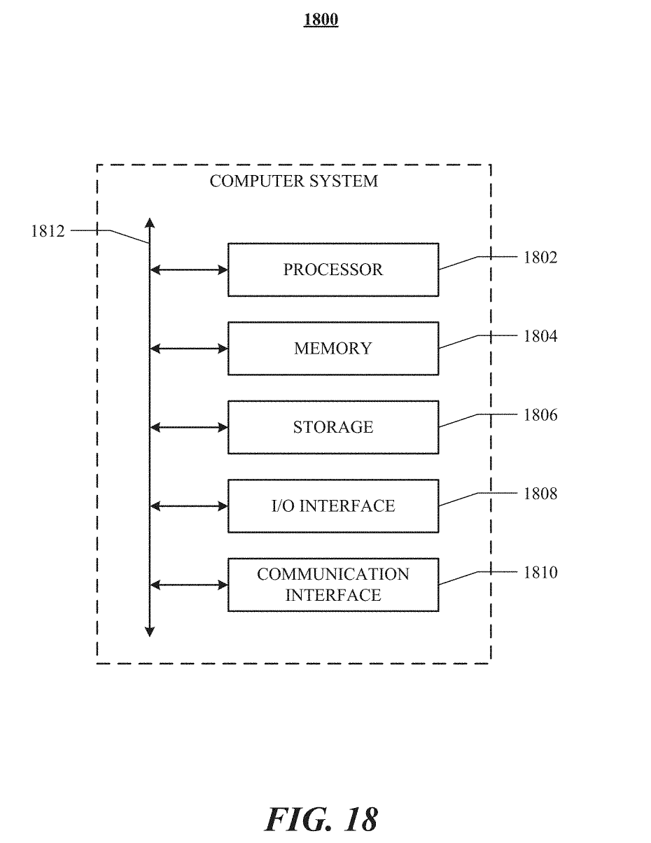

FIG. 18 illustrates an example computer system 1800. In particular embodiments, one or more computer systems 1800 perform one or more steps of one or more methods described or illustrated herein. In particular embodiments, one or more computer systems 1800 provide functionality described or illustrated herein. In particular embodiments, software running on one or more computer systems 1800 performs one or more steps of one or more methods described or illustrated herein or provides functionality described or illustrated herein. Particular embodiments include one or more portions of one or more computer systems 1800. Herein, reference to a computer system may encompass a computing device, and vice versa, where appropriate. Moreover, reference to a computer system may encompass one or more computer systems, where appropriate.

This disclosure contemplates any suitable number of computer systems 1800. This disclosure contemplates computer system 1800 taking any suitable physical form. As example and not by way of limitation, computer system 1800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1800 may include one or more computer systems 1800; be unitary or distributed; span multiple locations; span multiple machines; span multiple data centers; or reside in a cloud, which may include one or more cloud components in one or more networks. Where appropriate, one or more computer systems 1800 may perform without substantial spatial or temporal limitation one or more steps of one or more methods described or illustrated herein. As an example and not by way of limitation, one or more computer systems 1800 may perform in real time or in batch mode one or more steps of one or more methods described or illustrated herein. One or more computer systems 1800 may perform at different times or at different locations one or more steps of one or more methods described or illustrated herein, where appropriate.

In particular embodiments, computer system 1800 includes a processor 1802, memory 1804, storage 1806, an input/output (I/O) interface 1808, a communication interface 1810, and a bus 1812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1802 includes hardware for executing instructions, such as those making up a computer program. As an example and not by way of limitation, to execute instructions, processor 1802 may retrieve (or fetch) the instructions from an internal register, an internal cache, memory 1804, or storage 1806; decode and execute them; and then write one or more results to an internal register, an internal cache, memory 1804, or storage 1806. In particular embodiments, processor 1802 may include one or more internal caches for data, instructions, or addresses. This disclosure contemplates processor 1802 including any suitable number of any suitable internal caches, where appropriate. As an example and not by way of limitation, processor 1802 may include one or more instruction caches, one or more data caches, and one or more translation lookaside buffers (TLBs). Instructions in the instruction caches may be copies of instructions in memory 1804 or storage 1806, and the instruction caches may speed up retrieval of those instructions by processor 1802. Data in the data caches may be copies of data in memory 1804 or storage 1806 for instructions executing at processor 1802 to operate on; the results of previous instructions executed at processor 1802 for access by subsequent instructions executing at processor 1802 or for writing to memory 1804 or storage 1806; or other suitable data. The data caches may speed up read or write operations by processor 1802. The TLBs may speed up virtual-address translation for processor 1802. In particular embodiments, processor 1802 may include one or more internal registers for data, instructions, or addresses. This disclosure contemplates processor 1802 including any suitable number of any suitable internal registers, where appropriate. Where appropriate, processor 1802 may include one or more arithmetic logic units (ALUs); be a multi-core processor; or include one or more processors 1802. Although this disclosure describes and illustrates a particular processor, this disclosure contemplates any suitable processor.

In particular embodiments, memory 1804 includes main memory for storing instructions for processor 1802 to execute or data for processor 1802 to operate on. As an example and not by way of limitation, computer system 1800 may load instructions from storage 1806 or another source (such as, for example, another computer system 1800) to memory 1804. Processor 1802 may then load the instructions from memory 1804 to an internal register or internal cache. To execute the instructions, processor 1802 may retrieve the instructions from the internal register or internal cache and decode them. During or after execution of the instructions, processor 1802 may write one or more results (which may be intermediate or final results) to the internal register or internal cache. Processor 1802 may then write one or more of those results to memory 1804. In particular embodiments, processor 1802 executes only instructions in one or more internal registers or internal caches or in memory 1804 (as opposed to storage 1806 or elsewhere) and operates only on data in one or more internal registers or internal caches or in memory 1804 (as opposed to storage 1806 or elsewhere). One or more memory buses (which may each include an address bus and a data bus) may couple processor 1802 to memory 1804. Bus 1812 may include one or more memory buses, as described below. In particular embodiments, one or more memory management units (MMUs) reside between processor 1802 and memory 1804 and facilitate accesses to memory 1804 requested by processor 1802. In particular embodiments, memory 1804 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1804 may include one or more memories 1804, where appropriate. Although this disclosure describes and illustrates particular memory, this disclosure contemplates any suitable memory.

In particular embodiments, storage 1806 includes mass storage for data or instructions. As an example and not by way of limitation, storage 1806 may include a hard disk drive (HDD), a floppy disk drive, flash memory, an optical disc, a magneto-optical disc, magnetic tape, or a Universal Serial Bus (USB) drive or a combination of two or more of these. Storage 1806 may include removable or non-removable (or fixed) media, where appropriate. Storage 1806 may be internal or external to computer system 1800, where appropriate. In particular embodiments, storage 1806 is non-volatile, solid-state memory. In particular embodiments, storage 1806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1806 taking any suitable physical form. Storage 1806 may include one or more storage control units facilitating communication between processor 1802 and storage 1806, where appropriate. Where appropriate, storage 1806 may include one or more storages 1806. Although this disclosure describes and illustrates particular storage, this disclosure contemplates any suitable storage.

In particular embodiments, I/O interface 1808 includes hardware, software, or both, providing one or more interfaces for communication between computer system 1800 and one or more I/O devices. Computer system 1800 may include one or more of these I/O devices, where appropriate. One or more of these I/O devices may enable communication between a person and computer system 1800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1808 for them. Where appropriate, I/O interface 1808 may include one or more device or software drivers enabling processor 1802 to drive one or more of these I/O devices. I/O interface 1808 may include one or more I/O interfaces 1808, where appropriate. Although this disclosure describes and illustrates a particular I/O interface, this disclosure contemplates any suitable I/O interface.

In particular embodiments, communication interface 1810 includes hardware, software, or both providing one or more interfaces for communication (such as, for example, packet-based communication) between computer system 1800 and one or more other computer systems 1800 or one or more networks. As an example and not by way of limitation, communication interface 1810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1810 for it. As an example and not by way of limitation, computer system 1800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1800 may include any suitable communication interface 1810 for any of these networks, where appropriate. Communication interface 1810 may include one or more communication interfaces 1810, where appropriate. Although this disclosure describes and illustrates a particular communication interface, this disclosure contemplates any suitable communication interface.

In particular embodiments, bus 1812 includes hardware, software, or both coupling components of computer system 1800 to each other. As an example and not by way of limitation, bus 1812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1812 may include one or more buses 1812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing device associated with an aerial vehicle:
requesting, from an aerial-vehicle-transportation database, a driving map based on a three-dimensional representation of one or more transportation skyways, the three-dimensional representation comprising information regarding an x-axis and a y-axis representing movement in a first plane and information regarding a z-axis representing movement in a second plane perpendicular to the first plane;
receiving the driving map generated based on the information on the x-axis and the y-axis of movement, the driving map being determined based on the three-dimensional representation;
receiving information on altitude-transition zones associated with the z-axis of movement of the aerial vehicle along the second plane; and
storing, in a navigation system of the aerial vehicle, navigation information comprising the driving map and the altitude-transition zones.
